(19) United States
(12) Patent Application Publication
(10) Pub. No.: US 2023/0073859 A1
(43) Pub. Date: Mar. 9, 2023

(54) Digital Twin NFT Listing

(71) Applicant: eBay Inc., San Jose, CA (US)

(72) Inventors: Christopher Michael Matthews, Pacifica, CA (US); Andrew Chalkley, Portland, OR (US)

(73) Assignee: eBay Inc., San Jose, CA (US)

(21) Appl. No.: 17/468,963

(22) Filed: Sep. 8, 2021

(51) Int. Cl. G06Q 20/12; G06Q 20/38; G06Q 20/36; G06Q 30/06; G06Q 30/00; G06Q 30/02

(52) U.S. Cl. CPC G06Q 20/1235; G06Q 20/389; G06Q 20/367; G06Q 30/0633; G06Q 30/0185; G06Q 30/0206; G06Q 30/0631

(57) ABSTRACT

Listing NFTs associated with physical items is described. Input specifying at least one obligation to be performed as a condition for transferring an NET from a first digital wallet to a second digital wallet is received. A listing for the NFT is then generated with information that describes the NET and the at least one obligation. A smart contract template is also generated, which includes instructions that are configured to ensure performance of the at least one obligation and transfer the NET from the first digital wallet to the second digital wallet. Responsive to purchase of the NFT via the listing, a smart contract is generated by updating the smart contract template with an identifier of the second digital wallet, and the NFT is transferred by executing the smart contract using a distributed state machine implemented on a blockchain.

### BACKGROUND

Advances in technology, such as dramatic increases in computing power for smaller and smaller devices and development of more user-friendly tools for creating digital content, have led to the proliferation of digital content. Many creators of and/or persons responsible for popular digital content want to receive a benefit for their role in making such digital content popular and have the digital content treated as a digital asset (e.g., original digital content or digital content representing a physical item). Non-fungible tokens (NFTs) are one mechanism that enable digital content to be treated as digital assets, and do so by programmatically encoding a unique identity of an original asset that distinguishes it from copies of the asset. By using NFTs, an ownership lineage of the digital asset is also tracked via programmatic features of NFTs that ensure digital memorialization of any NET transfers.

Because of this ability to uniquely identify an asset from other assets and because of the functionality to record every transaction involving the asset, developments are being made to use NFTs in connection with physical items (e.g., unique and luxury goods). In contrast to transactions purely involving exchange of these physical items, however, transfer of a corresponding NET, either separately or together with its physical item counterpart, poses vastly different problems.

### SUMMARY

To overcome these problems, listing NFTs associated with physical items is described. Input specifying at least one obligation to be performed as a condition for transferring an NET from a first digital wallet to a second digital wallet is received. A listing for the NFT is then generated with information that describes the NFT and the at least one obligation. A smart contract template is also generated, which includes instructions that are configured to ensure performance of the at least one obligation and transfer the NET from the first digital wallet to the second digital wallet. Responsive to purchase of the NFT via the listing, a smart contract is generated by updating the smart contract template with an identifier of the second digital wallet, and the NET is transferred by executing the smart contract using a distributed state machine implemented on a blockchain.

This Summary introduces a selection of concepts in a simplified form that are further described below in the Detailed Description. As such, this Summary is not intended to identify essential features of the claimed subject matter, nor is it intended to be used as an aid in determining the scope of the claimed subject matter.

### BRIEF DESCRIPTION OF THE DRAWINGS

The detailed description is described with reference to the accompanying figures.

FIG. 1 is an illustration of an environment in an exemplary implementation that is operable to employ techniques described herein.

FIG. 2 depicts an example of a system to generate listings for NFTs associated with physical objects.

FIG. 3 depicts an example of a system to transfer an NFT between digital wallets in response to purchase of the NFT via a listing.

FIG. 4 depicts an example user interface including an NFT dashboard for a digital wallet.

FIG. 5 depicts an example user interface including additional details for an NFT selected from the NET dashboard of FIG. 4.

FIGS. 6-11 depict examples of user interfaces output as part of generating a listing for an NET associated with a physical object.

FIG. 12 depicts an example of a listing for an NET associated with a physical item.

FIG. 13 depicts a procedure in an example implementation of listing an NET associated with a physical item and transferring the NET between digital wallets.

FIG. 14 illustrates an example of a system that includes an example of a computing device that is representative of one or more computing systems and/or devices that may implement the various techniques described herein.

### DETAILED DESCRIPTION

### Overview

Conventional platforms that enable transferring ownership of physical items, such as online marketplaces, do not offer functionality that enables transferring ownership of digital twin NFTs for physical items. In contrast to conventional processes for transferring ownership of a physical item, where the physical item is materially delivered from a selling entity to a purchasing entity, transferring ownership of a digital twin NFT cannot be performed by physically placing the digital twin NFT “in the hand” of a purchasing individual. Consequently, offers for sale of digital twin NFTs involve considerations that are not contemplated by offers for sale of physical items, and conventional listing systems are not equipped with user interfaces or tools configured for listing digital twin NFTs.

To address these problems, a system and techniques for listing NETs associated with physical items are described. To facilitate generation of a listing for an NFT, the system identifies one or more NFTs stored in a digital wallet and generates an NFT dashboard configured for that particular digital wallet. The NET dashboard includes a bespoke collection of information presented in a user interface that displays information describing each of the one or more NFTs stored in the digital wallet, such as an identifier of the NET, a description of the NET, an ownership type of the NET, an estimated value of the NFT, properties of other NFTs that are similar to the NFT, and so forth. The NFT dashboard thus provides an entity associated with the digital wallet with a consolidated display of information describing NFTs that are available to be listed for sale and an indication of recommended properties for the listing (e.g., description, listing price, and the like). In some implementations, the NFT dashboard is configured to provide an alert indicating when an NFT associated with the digital wallet is detected as trending based on user behavior. One example of user behavior indicating that an NFT is trending includes an increased amount or frequency of keywords associated with the NFT being included in comments posted to social networking sites, search queries submitted to search engines, online and/or print publications, and so forth, relative to normal (e.g., historical averages) amounts or frequencies of the keywords. Other examples of user behavior indicating that an NFT is trending include increased views of listings related to the NET, increased purchase intent actions (e.g., adding to cart, adding to watchlist, bidding, etc.) made with respect to listings related to the NET, and so forth. The NFT dashboard is further configured to include a control for each NFT that is selectable to initiate generating a listing for sale of the NFT.

In response to detecting input at the control specifying that an NET is to be listed for sale, the system presents a plurality of user interfaces that include prompts for information describing aspects to be included in the NFT listing. In addition to prompting for input specifying a description of the NFT to be included in the listing, the user interfaces are configured to obtain input specifying conditions for transferring the NFT from a selling entity to a purchasing entity. Conditions for transferring the NFT may be specified in the form of obligations that must be performed to complete an NFT transfer, such as an obligation performed by a selling entity (e.g., ship physical item to a third-party for authenticity verification), an obligation to be performed by a purchasing entity (e.g., payment of a purchase price), or combinations thereof. The system codifies the obligations for transferring the NFT into a smart contract template for the listing, which includes code that is executable by a distributed state machine implemented by a blockchain to both ensure performance of the obligations and transfer the NFT from a selling entity to a purchasing entity responsive to verifying performance of the obligations.

The system then publishes the listing for viewing by a plurality of computing devices. In response to receiving a transfer request indicating a request to purchase the subject NET and agreement to perform obligations set forth in the listing, the system generates a smart contract for the listing. The system generates the smart contract for the listing by updating the smart contract template using an identifier associated with the computing device or entity from which the transfer request was received. Finally, the system facilitates transfer of the NFT by causing the distributed state machine implemented on the blockchain to execute the smart contract. By virtue of execution on the blockchain, a record of the listing, its associated obligations, and operations performed by the smart contract are memorialized in blockchain transaction data. The system is thus configured to automatically transfer the NET, ensure performance of obligations associated with the listing, and create an accurate ledger of transfer-related information without requiring involvement of an intervening third party.

In the following discussion, an exemplary environment is first described that may employ the techniques described herein. Examples of implementation details and procedures are then described which may be performed in the exemplary environment as well as other environments. Performance of the exemplary procedures is not limited to the exemplary environment and the exemplary environment is not limited to performance of the exemplary procedures.

### Example of an Environment

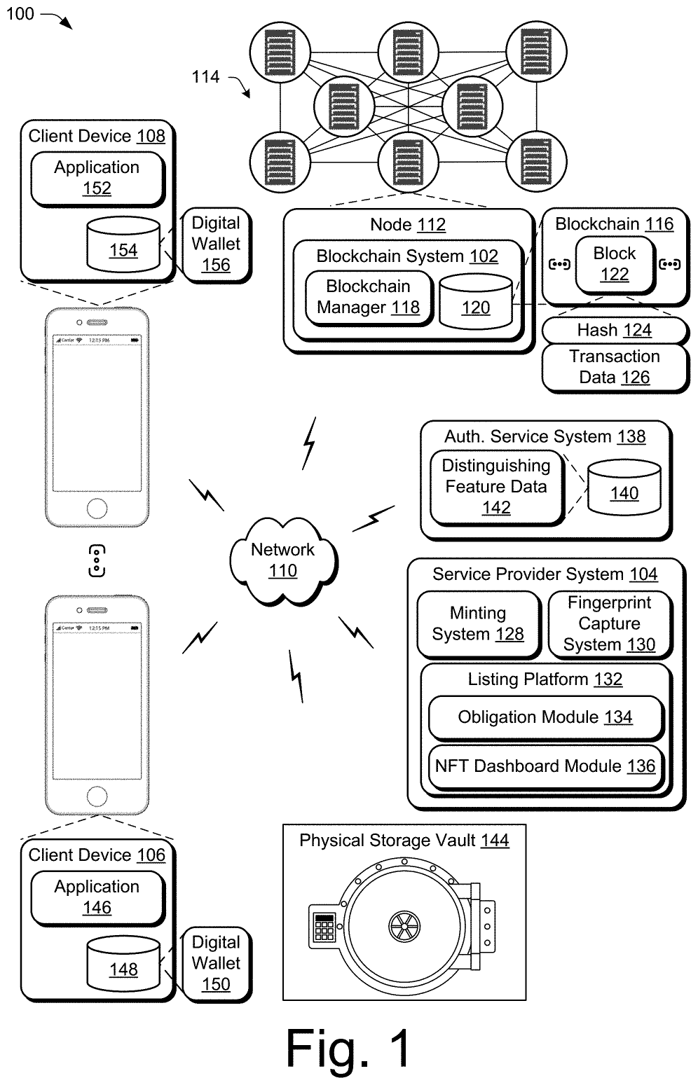

FIG. 1 is an illustration of an environment 100 in an example implementation that is operable to employ techniques described herein. The environment 100 includes a blockchain system 102, a service provider system 104, and a plurality of client devices (represented in the environment 100 by client device 106 and client device 108) that are communicatively coupled, one to another, via a network 110.

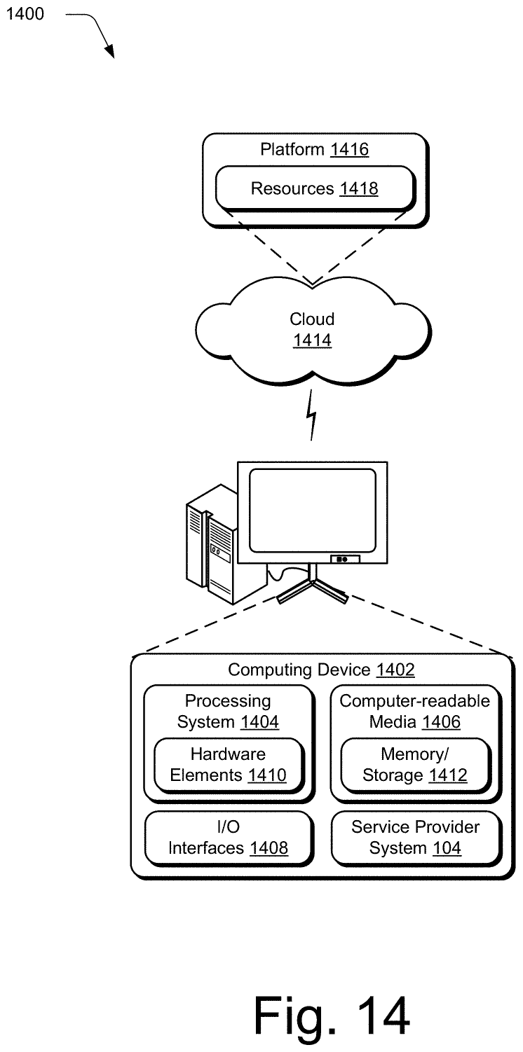

Computing devices that implement the environment 100 are configurable in a variety of ways. A computing device, for instance, is configurable as a desktop computer, a laptop computer, a mobile device (e.g., assuming a handheld configuration such as a tablet or mobile phone), an IoT device, a wearable device (e.g., a smart watch), an AR/VR device, a server, and so forth. Thus, a computing device ranges from full resource devices with substantial memory and processor resources to low-resource devices with limited memory and/or processing resources. Additionally, although in instances in the following discussion reference is made to a computing device in the singular, a computing device is also representative of a plurality of different devices, such as multiple servers of a server farm utilized to perform operations “over the cloud” as further described in relation to FIG. 14.

In accordance with the described techniques, the blockchain system 102 is implemented by a node 112 of a network 114 (e.g., a distributed network) of the nodes 112. Each of the nodes 112 is a runtime implemented using processing, memory, and network resources of respective computing devices that operate as the infrastructure of a blockchain 116. Here, the blockchain system 102 is illustrated including blockchain manager 118 and storage 120, with storage 120 being an example of one or more computing resources leveraged to implement the node 112. The blockchain system 102 also includes other resources of the one or more respective computing devices made available for operating as the node 112. In this manner, the blockchain manager 118 is configured to leverage resources of the one or more respective computing devices made available for operating as the node 112 to implement the node 112 on behalf of the one or more computing devices.

By way of example, the blockchain manager 118 manages the storage 120 of the one or more computing devices implementing the node 112, such as by causing a copy of the blockchain 116 to be maintained in the storage 120. The copy of the blockchain 116 stored at the storage 120 may be a partial or full copy of the blockchain 116, depending on one or more characteristics of the node 112 (e.g., a type) and/or a time (e.g., whether updates have been made to the blockchain 116 via other nodes 112 in the network 114). In some implementations, the blockchain manager 118 manages other resources of one or more computing devices implementing the node 112 in connection with operation of the blockchain 116, such as memory and processors of those devices to perform computations (e.g., transaction validation), operating systems of those devices, and network connections of those devices (e.g., to commit changes to the blockchain 116 and to receive updates to the node 112's copy of the blockchain), and so forth. Thus, the nodes 112 are representative of computing resources configured to store, communicate, process, and manage data that makes up the blockchain 116. As illustrated in FIG. 1, the nodes 112 are interconnected to exchange data via the network 110, e.g., as a peer-to-peer network in a distributed and decentralized manner.

Blockchain 116 is formed using a plurality of blocks 122, illustrated in FIG. 1 as each including a respective hash 124 and transaction data 126. The transaction data 126 of the blocks 122 includes batches of validated transactions that are hashed and encoded. Each of the blocks 122 includes hash 124, which is a cryptographic hash of a previous block 122 in the blockchain 116, thereby linking the blocks 122 to each other and forming the blockchain 116. Consequently, individual ones of the blocks 122 cannot be altered retroactively without altering each block 122 subsequently added to the blockchain 116, thereby protecting blocks 122 of the blockchain 116 from attacks by malicious parties.

In order to publish the blocks 122 for addition to the blockchain 116, at least one node 112 is implemented as a “miner” configured to add a block of transactions to the blockchain 116. In one or more implementations, other nodes communicate transactions received at those nodes to one or more mining nodes for validation. Mining nodes are configured to perform peer-to-peer computations to determine whether transactions intended for the blockchain 116 are valid and, if validated, add validated transactions to a block 122 that those nodes are building. If the transactions are determined to be valid, the transaction data 126 describing valid transactions is encoded in, or otherwise stored on, a respective block 122, which is linked to the blockchain 116 such that the new block is “at the end” or “at the top” of the blockchain 116 (e.g., through inclusion of the hash 124 of a previous block 122 in the chain).

The nodes 112 are configured to broadcast this transaction history via the network 110 for sharing with other nodes 112. By broadcasting and sharing the transaction history with other nodes 112, the blocks 122 of the blockchain 116 are synchronized across the distributed architecture of computing devices that make up the distributed network 114. A variety of “types” of nodes 112 may be used to implement the blockchain 116. By way of example, the blockchain 116 may be implemented at least in part using “full” nodes, which are nodes that store an entirety of the blockchain 116 (e.g., locally in computer-readable storage media of respective computing devices of the nodes 112). Other types of nodes may also be employed to implement alternative or additional functionality such as governing voting events, governing execution of protocol operations, enforcing rules, and so forth.

The blockchain 116 is thus configured to provide a diverse range of functionality. Due in part to the storage and updating of the blockchain 116 over the distributed network 114 of nodes 112, the blockchain 116 is configured to store its data in a decentralized manner, without a centralized database (e.g., run by a clearinghouse or intermediary entity), and thus operate as a distributed ledger. The decentralized storage of the blockchain 116 advantageously avoids susceptibility to a single point of failure compromising the entire storage system, which is a primary shortcoming of centralized storage. In one or more implementations, the blockchain 116 is configured as a public blockchain (e.g., as an Ethereum or a Bitcoin public blockchain), such that transactions on the blockchain 116 are generally viewable with a connection to the Internet. Alternatively, in some implementations the blockchain 116 is configured as a private blockchain. When the blockchain 116 is configured as a private blockchain, the computing devices used to implement the nodes 112 are controlled by a centralized authority, such as a company or a consortium of entities that restricts access to transactions stored by the blockchain 116 ledger (e.g., the transaction data 126).

As a distributed ledger, the blockchain 116 supports secure transfer of digital assets, such as transfer of a cryptocurrency and/or tokens. As referenced herein, cryptocurrencies (e.g., coins of the cryptocurrency) refer to assets native to blockchains, in contrast to tokens, which are created “on top” of these blockchains. For example, tokens are created “on top” of the blockchain 116 using a “token standard,” which enables the token to interoperate with the blockchain 116's network of nodes 112 according to one or more protocols of the blockchain, such that the transaction data 126 and the hashes 124 of the blocks 122 are leveraged to create, trade, and update tokens. By way of example, the Ethereum blockchain's native asset is ether (ETH), a cryptocurrency. Nevertheless, tokens may be created on top of Ethereum's blockchain by using one or more of Ethereum's token standards for creating tokens, such as by using ERC-20, ERC-721, ERC-1155, and EIP-2309, to name just a few.

The tokens created on top of the blockchain 116 are configured to be “programmable,” meaning that the tokens run on software protocols and can be configured to include logic executed by computing resources (e.g., computing resources provided by the nodes 112). In this manner, the tokens are configured to implement smart contracts that define conditions for rules of engagement between the token and the distributed network 114. As referenced herein, a “smart contract” refers to an application including code configured to carry out a set of instructions that define terms of a contractual relationship between blockchain entities. When executed, a smart contract causes the blockchain 116 to validate and enforce the set of instructions included in the smart contract. For instance, executing the code of a smart contract may be performed by sending the code to an address on the blockchain 116 as a blockchain transaction and, at the address, validating the received code (e.g., by a consensus mechanism of the blockchain 116). Once validated, this transaction may be included in a block 122, such that the smart contract is initiated and irrevocable.

Smart contracts are thus useable to automate the execution of an agreement between parties on the blockchain 116 (e.g., an agreement between client device 106 and client device 108). As described in further detail below, a smart contract can be configured to automate a portion or entirety of a workflow by triggering performance of actions responsive to satisfaction of one or more conditions described in the code of the smart contract (e.g., coded as a series of if/when/then statements on the blockchain 116). In this manner, a smart contract is not limited as to a number or type of included stipulations, thereby enabling blockchain 116 participants to freely establish terms and conditions for establishing and facilitating a contractual relationship and ensure performance without the need for a third-party intermediary. Because the terms of a smart contract and results of workflow transactions initiated by the smart contract are necessarily stored in transaction data 126 of the blockchain 116, the smart contracts described herein provide trust and transparency between parties by ensuring performance of stipulated obligations and generating accurate transaction records that are securely maintained by the blockchain 116.

In some implementations, contractual relationships on the blockchain 116 involve tokens (e.g., implemented according to a token standard such as ERC-721 or ERC-1155). By leveraging the architecture and protocols of the blockchain 116, tokens are configured to be programmatically encoded as non-fungible assets that are individually unique and cannot be directly interchanged with other similar tokens “like-for-like.” For instance, the architecture and protocols of the blockchain 116 are configured to create non-fungible tokens (NFTs) on the blockchain 116. By using the transaction validation carried out by the nodes 112, the blockchain 116 certifies that a given NET is digitally unique and thus not interchangeable with other NFTs. When an NFT is minted (i.e., programmatically brought into existence), the blockchain 116's protocols generate a unique token identifier that is encoded in the NET—the unique identifier may be generated using one or more randomization approaches. As used herein, the term “non-fungible” refers to the property of a token to uniquely represent an asset, such that a digital signature of the token represents the underlying asset in a way that is not directly interchangeable with (e.g., “like-for-like”), or equal to, any other tokens. This contrasts with cryptocurrencies, which are “fungible” because two coins of a same cryptocurrency (e.g., two Ether or two Bitcoins) can be traded or exchanged for one another and are of equal value.

Instead, each NFT is programmatically created to include a unique, non-transferable identity that distinguishes it from other NFTs. In one or more implementations, an NET encodes underlying digital content (e.g., digital art, an image, music, a video, in-game content, a textual composition, a file, a 3D-model, combinations thereof, and so forth). Alternatively or additionally, an NFT encodes an association with or to the digital content (e.g., a uniform resource locator (URL) or other location information that describes a location where the digital content and/or data about the digital content is stored). For instance, rather than encoding the digital content for storage in the NFT, the digital content may be stored in third-party storage (e.g., storage of the service provider system 104 or storage of another service provider). As described herein, an NFT created and maintained on the blockchain 116 is configured to encode other information in addition to underlying digital content, or an association with the underlying digital content.

In accordance with the techniques described herein, the service provider system 104 includes a variety of functionality for creating NFTs and executing transactions involving NFTs. For instance, the service provider system 104 is configured to facilitate listing NFTs for sale (e.g., recommending a price for an NET listing, providing templates to generate an NET listing, etc.), purchasing NFTs, creating smart contracts with different terms defining obligations (e.g., royalties, temporal ownership conditions, fractional ownership structures and rules, etc.) that govern transactions involving an NET, initiating execution of smart contracts encoded by NFTs, and so forth. As illustrated herein, the service provider system 104 includes a minting system 128, a fingerprint capture system 130, and a listing platform 132. The listing platform 132 is configured to include an obligation module 134, which is representative of functionality of the listing platform 132 to provide user interfaces that facilitate designation of one or more obligations for an NFT transaction and create smart contracts that enforce the designated one or more obligations. The listing platform 132 is further configured to include an NFT dashboard module 136, which is representative of functionality of the listing platform to output information pertaining to one or more NFTs stored on the blockchain 116, such as trending searches for keywords related to the NFT, an estimated value for the NFT, and so forth.

Although depicted in the illustrated example of FIG. 1 as being implemented separately from the service provider system 104, in some implementations the service provider system is configured to incorporate functionality of an authentication service system 138. The authentication service system 138 is configured as including storage 140, which includes distinguishing feature data 142. The distinguishing feature data 142 is useable by the authentication service system 138 to authenticate physical items, such as physical items for which digital twin NFTs are created in accordance with the techniques described herein.

The illustrated example of FIG. 1 is merely representative of an example configuration of the service provider system 104, and in implementations the service provider system 104 may include more, fewer, and/or different components than illustrated without departing from the spirit or scope of the described techniques. Additionally, portions or entireties of one or more of the components may be implemented at client devices, such as part of applications at the client device 106 and/or the client device 108. For instance, at least a portion of the fingerprint capture system 130 (and/or the other illustrated components) may be implemented at the client devices 106 and/or 108 (e.g., as at least part of an application, as a plug-in, via a web page output by the client devices, and so forth).

The illustrated environment 100 also includes physical storage vault 144, which is representative of a physical location configured to store physical items having digital twinned NFTs for safe keeping. In some implementations, the physical storage vault 144 is a physical location controlled by an entity associated with the service provider system 104. Alternatively, in some implementations the physical storage vault 144 is controlled by a third party contractually associated with the service provider system 104 to securely store and maintain physical items having one or more digital twin NFTs.

To enable respective users to initiate operations to create NFTs and to perform transactions involving NFTs, the client device 106 and the client device 108 include components to interact within the environment 100. The client device 106 is illustrated including application 146 (e.g., a computer application) and storage 148, which is depicted storing digital wallet 150. The client device 108 is illustrated including application 152 (e.g., a computer application) and storage 154, which is depicted storing digital wallet 156. The applications 146 and 152 may be configured in a variety of ways in accordance with the techniques described herein. For example, the applications 146 and 152 may be mobile applications, plug-ins, or web-browsers to access web pages providing NET-based services, to name just a few. The applications 146 and 152 may be separate installations of a same application (e.g., a mobile application of the service provider system 104). Alternatively or additionally, the applications 146 and 152 may correspond to a digital wallet service provider (not depicted), which provides respective digital wallets 150 and 156. Alternatively or in addition, the digital wallets 150 and 156 may be accessible to the respective applications 146 and 152 (e.g., via an application programming interface (API)), to carry out operations involving NFTs on the blockchain 116.

By way of example, the respective applications 146 and 152 are configured to receive user input via a user interface to initiate ownership transfer of an NET from a user associated with the client device 106 to a user associated with the client device 108, e.g., by transferring the NFT from the digital wallet 150 to the digital wallet 156. The digital wallets 150, 156 are configured to store public and private cryptographic keys that digitally link transactions on the blockchain 116 to user accounts corresponding to the wallets. Generally, the information stored on the wallets may point to assets' locations in terms of blocks on the blockchain and there is a unique cryptographic address issued by a wallet, such that the transaction data 126 encodes wallet addresses of parties to the transaction. In some implementations, minting a digital twin NET for a physical item includes encoding a wallet address, user account information, or other identifier of an entity minting the NET.

To mint an NFT, the minting system 128 causes the NET to be created on the blockchain 116 and programmatically encodes an association of metadata with the NET. In accordance with the described techniques, for example, the minting system 128 is configured to mint digital twin NFTs of physical items. The metadata for a digital twin NFT may include a fingerprint of the physical item (e.g., a high-resolution image of one or more features of the item, a LIDAR scan of the physical item, etc.) and digital content of the physical item (e.g., an image of the physical item for presentation, a video of the physical item, and/or a 3D model of the physical item). The metadata may also include other information, such as a description of the item, a condition of the physical item (which can change over time), an indication that the physical item is an authentic physical item, an indication that the physical item is not an authentic physical item, a physical location where the item was minted (e.g., at a residence, at a location corresponding to a facility of the service provider system, at an event such as a concert or sporting event, and so on), locations of transactions involving the physical item, public addresses of wallets of owners of the NFT, and/or a current location of the physical item, to name just a few.

The minting system 128 is configured to encode an association of this metadata with the digital twin NET by, for example, encoding the actual data (e.g., the unique fingerprint and/or the digital content) in the digital twin NFT, encoding unique identifiers of the actual data in the digital twin NFT, and/or encoding one or more addresses where such data is located (e.g., a storage location) in the digital twin NET. In operation, the minting system 128 provides data as specified by a token standard associated with the blockchain 116 to one or more of the nodes 112 to mint a new digital twin NFT of a physical item. For example, the minting system 128 packages and communicates the actual metadata to be encoded and/or packages and communicates the association (e.g., identifier and/or addresses) to be encoded according to the token standard to the one or more nodes 112. In some implementations, the minting system 128 is configured to verify that an entity is authorized to mint a digital twin NET of a physical item prior to minting the digital twin NFT. For instance, absent any restrictions, an entity is permitted to mint any number of digital twin NFTs for a single physical item. Using the techniques described herein, a listing for a physical item and/or its associated digital twin NFT may be generated with a restriction against minting further digital twin NFTs for the physical item, as described in further detail below.

The fingerprint capture system 130 is configured to generate digital fingerprints of physical items that uniquely identify a given physical item and differentiate the given physical item from other physical items. The fingerprint capture system 130 generates a fingerprint based on captured features of a physical items, such as features captured using sensors of one or more devices. As discussed below, the features may be captured using one or more sensors of client devices (e.g., the client devices 106, 108), one or more sensors of the fingerprint capture system 130 (e.g., when configured with hardware to capture the features of physical devices), and/or sensors of other devices. By way of example, the client devices and/or the fingerprint capture system 130 may include a high-resolution digital camera to capture high-resolution digital image features of physical items.

The authentication service system 138 is configured to verify whether a physical item corresponds to an authentic physical item. The authentication service system 138 may verify whether a physical item corresponds to an authentic physical item by matching the fingerprint of a physical item, as generated by the fingerprint capture system 130, to distinguishing feature data 142 of a known authentic physical item. The authentication service system 138 may do so by comparing a fingerprint, or captured features encoded in the fingerprint, to portions of the distinguishing feature data 142, e.g., searching the distinguishing feature data 142 for data having at least a threshold similarity to the fingerprint or portions of the fingerprint. The authentication service system 138 may then return a response indicating that a physical item is or is not an authentic physical item (or is unsure whether the physical item is or is not authentic) based on whether the fingerprint matches any of the distinguishing feature data 142.

The listing platform 132 is configured to generate listings for items and to expose those listings (e.g., publish them via a digital marketplace) to one or more client devices. For example, the listing platform 132 may generate listings for items for sale and expose those listings to client devices, such that the users of the client devices can interact with the listings via user interfaces to initiate transactions (e.g., purchases, add to wish lists, share, and so on) in relation to the respective item or items of the listings. In accordance with the described techniques, the listing platform 132 is configured to generate listings for physical items or property (e.g., collectibles, luxury items, clothing, electronics, real property, physical computer-readable storage having one or more video games stored thereon, and so on), services (e.g., babysitting, dog walking, house cleaning, and so on), digital items (e.g., digital images, digital music, digital videos) that can be downloaded via the network 110, NFTs, combinations thereof, and so forth. Notably, the listing platform 132 is configured to generate a listing that specifies one or more obligations for transferring a subject (e.g., an NET) of the listing between contracting parties (e.g., between digital wallet 150 and digital wallet 156).

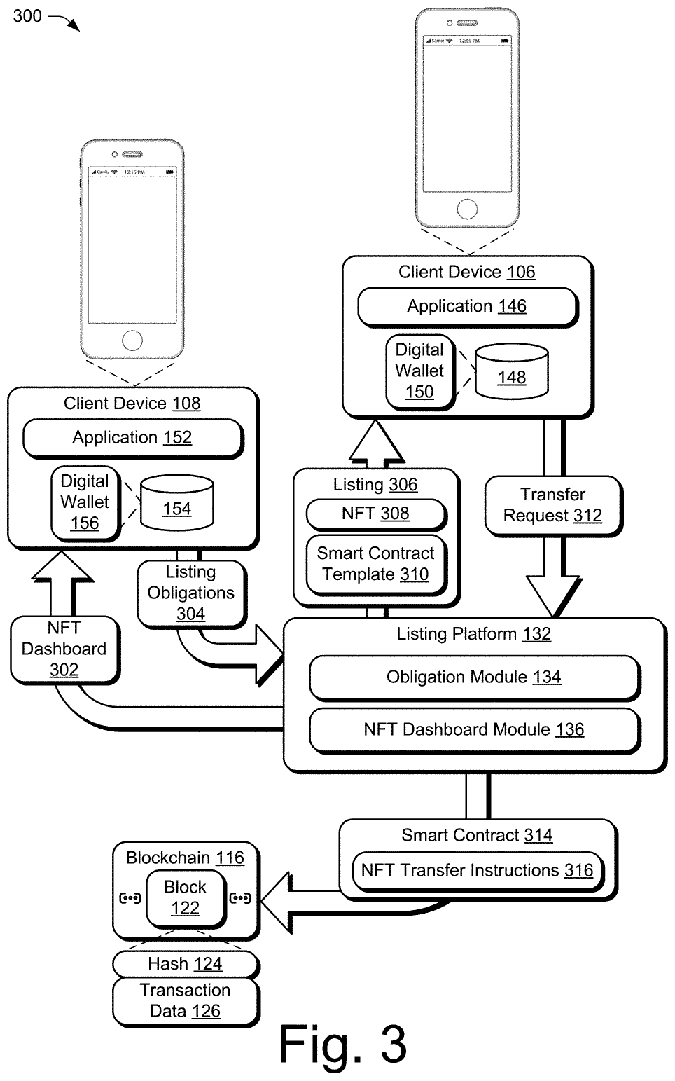

To facilitate specification of these one or more obligations, the listing platform 132 includes an obligation module 134, which is configured to output display of user interfaces that prompt user input defining parameters for the one or more obligations. In some implementations, user interfaces provided by the obligation module 134 are output in response to input received at an interface presented by the NET dashboard module 136, as described in further detail below with respect to FIGS. 3-5. Based on user input received by the obligation module 134 from a client device associated with a user account (e.g., of the service provider system 104), the listing platform 132 generates a listing together with a smart contract template that includes executable instructions for enforcing performance of the one or more obligations and facilitating transfer of the subject(s) of the listing responsive to verifying performance of the one or more obligations. The smart contract template can then be updated by the service provider system 104 with an identifier of an entity purchasing the subject(s) of the listing to generate a smart contract, which is executable by the blockchain system 102 to facilitate a transfer of the subject(s) of the listing according to obligations defined by the listing.

In some implementations, the service provider system 104 is configured to store physical items associated with a listing at the physical storage vault 144, such as valuable physical items having digital twin NFTs. Storage of the underlying physical item at the physical storage vault 144 allows ownership of the digital twin NET and the physical item to be easily transferred between owners without the hassle of physically moving the item to transfer possession (e.g., shipping the item or exchanging it between hands). Instead, the item may be transferred to the physical storage vault 144 for storage and remain in the physical storage vault 144 while ownership of the physical item and/or its digital twin NET is transferred a number of times. The physical storage vault 144 may also maintain physical items where ownership is divided, using a digital twin NFT, into a number of fractions of ownership of the physical item, e.g., “shares” of the physical item issued according to terms of the digital twin NFT. Alternatively or additionally, the physical storage vault 144 may be leveraged to store physical items in implementations where digital twin NFTs are sold with an option to purchase the physical item counterpart at a later date, such that storage in the physical storage vault 144 ensures a maintained quality and condition of the physical item.

Having considered an example of an environment, consider now a discussion of some examples of details of the techniques for generating listings for NFTs in accordance with one or more implementations.

Listing of Physical Items' Digital Twin NFTs

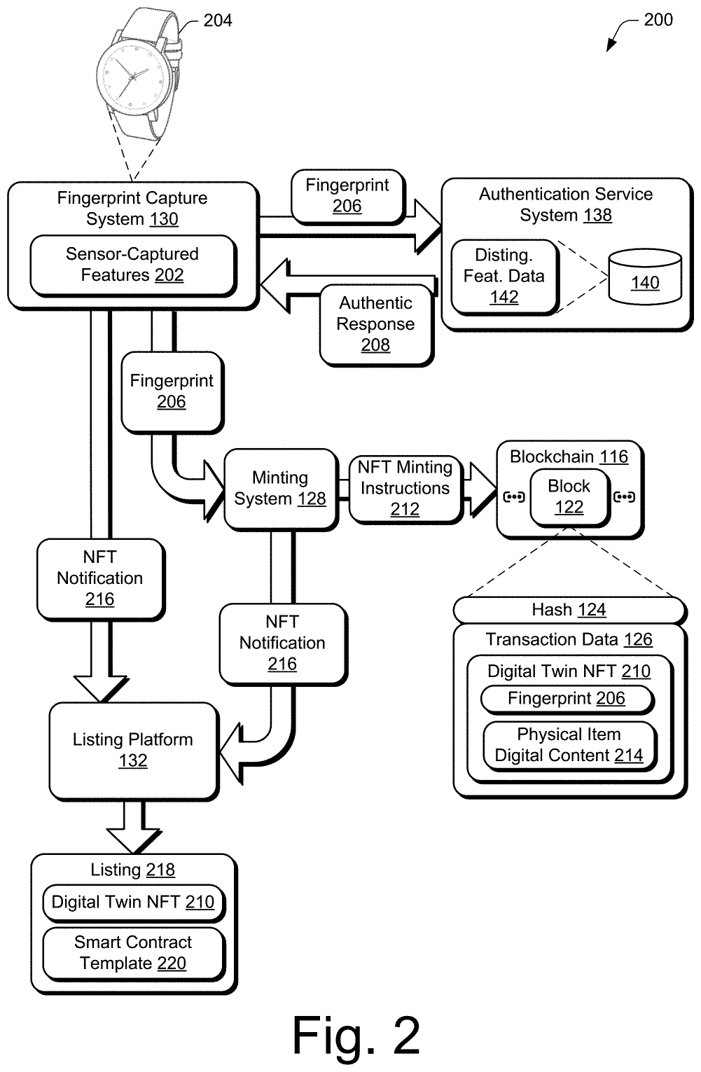

FIG. 2 depicts an example of a system 200 to generate listings for NFTs associated with physical objects.

The illustrated example of FIG. 2 includes the blockchain 116, the fingerprint capture system 130, the authentication service system 138, the minting system 128, and the listing platform 132 with its obligation module 134 and NFT dashboard module 136, as introduced in FIG. 1.

In FIG. 2, the fingerprint capture system 130 is depicted obtaining sensor-captured features 202 of physical item 204. In accordance with the described techniques, the sensor-captured features 202 correspond to data describing one or more aspects of the physical item 204 captured using sensors of one or more devices. For instance, the sensor-captured features 202 may be obtained using one or more sensors of the client device 106, the client device 108, the fingerprint capture system 130, combinations thereof, and so forth.

By way of example, the fingerprint capture system 130 is implemented at least partially at a client device (e.g., a client device 106, 108) having the one or more sensors. Alternatively or additionally, the fingerprint capture system 130 is configured as, includes a receptable into which, or a platform onto which, physical items are placed so that sensors of the fingerprint capture system 130 scan the item to generate the sensor-captured features 202.

Examples of sensors that are useable to generate the sensor-captured features 202 include, but are not limited to, imaging sensors (e.g., one or more high-resolution digital cameras, one or more low-resolution digital cameras), temperature sensors, LIDAR, biochemical sensors, and so on. Examples of the sensor-captured features 202 may include, but are not limited to, images (e.g., high-resolution images depicting features of the physical item 204), videos of the physical item 204, data derived from various electromagnetic spectrum features captured by the sensors about the physical item 204, measured temperatures at different locations of the physical item 204 (or a map of them), a LIDAR scan of the physical item 204, and/or measurements (or estimated values) of one or more elements or compounds at different locations of the physical item 204, to name just a few. Thus, the sensor-captured features 202 may be produced by a variety of sensors of different devices and describe a variety of features about the physical item 204 without departing from the spirit or scope of the techniques described herein.

Using the sensor-captured features 202, the fingerprint capture system 130 generates a fingerprint 206 of the physical item 204. The fingerprint 206 is unique to the physical item 204 and may be used to uniquely identify the physical item 204 from other physical items, including from another specimen of the same item (e.g., two luxury watches of the same brand, make, model, etc.). For example, the fingerprint 206 may be configured as a unique digital signature that identifies the physical item 204 from other physical items. Notably, the fingerprint capture system 130 can generate the fingerprint 206 to digitally encode the sensor-captured features 202 of the physical item 204 at various points in time after manufacture of the physical item 204. In other words, the fingerprint capture system 130 is not reliant on the manufacturing process to generate the fingerprint 206 so that it uniquely identifies the physical item 204. In this manner, the fingerprint capture system 130 is configured to generate the fingerprint 206 without modifying the physical item 204. This contrasts with techniques that rely on an identifier to be manufactured into or otherwise incorporated with the physical item 204, examples of which include configuring a physical item with an RFID tag and/or applying (e.g., stitching in or printing) an identifier to the physical item.

In accordance with the described techniques, the authentication service system 138 is configured to authenticate the physical item 204 based on the fingerprint 206. The fingerprint capture system 130 is configured to transmit the fingerprint 206 to the authentication service system 138 for authentication, in accordance with the techniques described herein. For instance, in implementations where the fingerprint capture system 130 is integrated at least in part at a client device, (e.g., as part of the application 146 at the client device 106 and/or as part of the application 152 at the client device 108), the client device is configured to transmit the fingerprint 206 to the authentication service system 138 (e.g., over the network 110).

The authentication service system 138 is configured to verify that the physical item 204 corresponds to an authentic physical item. To do so, the authentication service system 138 compares the fingerprint 206 to the distinguishing feature data 142 stored in the storage 140. The distinguishing feature data 142 describes features of one or more physical items that are known to be authentic and is saved in the storage 140. The authentication service system 138 is capable, through a computerized comparison of the digital fingerprint 206 and the distinguishing feature data 142, of identifying authentic items and/or differentiating authentic items from items that are not authentic (e.g., knockoffs). Some of the comparison techniques used by the authentication service system 138 are not possible to be performed by humans alone due to humans lacking the sensory capacity to detect one or more of the same features and/or compare digital fingerprints to the distinguishing feature data 142 at the level required to identify a physical item as authentic.

If the authentication service system 138 identifies a match between the fingerprint 206 and the distinguishing feature data 142, then the authentication service system 138 determines that the physical item 204 is an authentic physical item. Alternatively, if the authentication service system 138 does not identify a match between the fingerprint 206 and the distinguishing feature data 142, then the authentication service system 138 may determine that the physical item 204 is not an authentic physical item. In one or more implementations, the authentication service system 138 identifies a match between the fingerprint 206 and the distinguishing feature data 142 based on identifying a threshold similarity between the fingerprint 206 and the distinguishing feature data 142 for the physical item 204. In this way, a physical item that is not identical to a known authentic item but is “close enough” to have a high likelihood of being authentic, may be determined authentic by the authentication service system 138, such that the physical item 204 is considered a “match” to an authentic physical item. For instance, consider an example scenario where a fingerprint 206 is generated for a certain model and colorway of shoes (e.g., Air Jordan l's in a black/red colorway). In this example scenario, the distinguishing feature data 142 against which the fingerprint 206 is compared may have been generated using a different pair of shoes in the same model and colorway as the “known authentic item.” Although the fingerprint 206 itself is not derived from the known authentic item in this example scenario, the authentication service system 138 is configured to identify the model and colorway of shoes as matching the known authentic item.

Based on matching the fingerprint 206 to data in the distinguishing feature data 142, the authentication service system 138 provides an authentic response 208, indicating that the physical item 204 is an authentic physical item. In the illustrated example, for instance, the authentication service system 138 communicates the authentic response 208 to the fingerprint capture system 130. Alternatively or additionally, the authentication service system 138 is configured to communicate the authentic response to a system other than the fingerprint capture system, such as to the service provider system 104, one or more of client devices 106 or 108, and so forth. In an example scenario where the authentication service system 138 does not find a suitable match between the fingerprint 206 and the distinguishing feature data 142, the authentication service system 138 may determine that the physical item 204 is not authentic and may communicate a response indicating that the physical item 204 is not authentic (e.g., to the fingerprint capture system 130, to the service provider system 104, to one or more of the client devices 106 or 108, and so forth).

In implementations where the fingerprint 206 is to be used for minting a new NFT for the physical item 204, the fingerprint 206 is communicated to the minting system 128. Receipt of the fingerprint 206 by the minting system 128 may be responsive to the authentic response 208 indicating that the physical item 204 is an authentic physical item. In one or more scenarios, however, the minting system 128 may receive the fingerprint 206 for an item that is determined not to be authentic by the authentication service system 138.

Upon receipt of the fingerprint 206, the minting system 128 is configured to cause a digital twin NFT 210 of the physical item 204 to be minted on the blockchain 116. To do so, the minting system 128 provides NFT minting instructions 212 to one or more of the nodes 112 in the distributed network 114 of FIG. 1. The NFT minting instructions 212 may be configured according to, and include data specified by, a token standard (e.g., ERC-721 or ERC-1155) for creating the digital twin NFT 210. Once created, the digital twin NET 210 has a unique token identifier that uniquely identifies the token from other tokens. For instance, the token identifier may be a unit 256 variable. Information included in the NET minting instructions 212 enables a node 112 to programmatically encode in the digital twin NFT 210 information provided or indicated in the NFT minting instructions 212. For example, the NET minting instructions 212 may include an association with metadata, such as an association with the fingerprint 206, physical item digital content 214, an identifier of a user account that initiated minting of the physical item 204, an ownership history of the physical item 204, a description of the physical item 204, and so forth. The node 112 receiving the NFT minting instructions 212 is thus caused to encode the association with the metadata into the digital twin NFT 210.

In the illustrated example, the digital twin NFT 210 is depicted as including the fingerprint 206 and the physical item digital content 214. In one or more implementations, however, the digital twin NFT 210 may include references to the fingerprint 206 and the physical item digital content 214 instead of the actual content itself. Such references may be configured as pointers to the actual content (e.g., URLs or storage locations) and/or unique identifiers (e.g., GUIDE) of the actual content. By encoding associations with the actual content rather than encoding the actual digital content (e.g., the fingerprint 206 and/or the physical item digital content 214), the minting system 128 may limit the use of hardware resources (e.g., processing) of the nodes 112 for minting the digital twin NFT 210. By limiting an amount of resources used, the minting system 128 may proportionally reduce a “gas” fee required by the blockchain 116 to utilize those resources and mint the digital twin NET 210.

As noted above, the digital twin NET 210 may also programmatically encode other information. For example, the digital twin NFT 210 may programmatically encode a public address of a digital wallet of a user associated with minting the NET, e.g., a public address of the digital wallet 150 in a scenario where a user associated with the client device 106 provides user input via a user interface to mint the digital twin NFT 210. The digital twin NET 210 may also be configured to digitally record a provenance of the NFT, such that ownership information is captured each time the digital twin NFT 210 is transferred (in whole or in part). For example, if the minting user transfers the digital twin NFT 210 to a new user, then the transfer from the wallet address of the minting user to a wallet address of the new user is recorded in the digital twin NFT 210's data on the blockchain 116. As with other transactions on the blockchain 116, one or more of the nodes 112 validates such a transfer so that only valid transfers are committed to the blockchain 116.

The digital twin NFT 210 may be minted to encode other data, examples of which include smart contracts (e.g., to govern royalties, fractional ownership processes and events, end-of-life of the NFT events, and so forth), and/or a description of other aspects of the physical item 204 (e.g., a condition of the physical item 204, provenance of different parts of the physical item 204, maintenance record of the physical item 204, and so forth). The digital twin NFT 210 may also be minted to encode various metadata, such as a description of the physical item 204, a condition of the physical item 204 (which can change over time), an indication that the physical item 204 is an authentic physical item, an indication that the physical item 204 is not an authentic physical item, a physical location where the physical item 204 was minted (e.g., at a residence, at a location corresponding to a facility of the service provider system, at an event such as a concert or sporting event, and so on), locations of transactions involving the physical item 204, and/or a current location of the physical item 204, to name just a few examples.

With regard to a physical item's condition, the service provider system 104 may be configured to determine a condition of a physical item and capture the determined condition as a state in the digital twin NFT 210 or other data associated with the physical item 204. In one or more implementations, the service provider system 104 may be configured to determine a condition of the physical item 204 using the sensor-captured features 202. The service provider system 104 may further be configured to generate or set metadata (e.g., a state) describing the determined condition of the physical item 204. To this end, the minting system 128 may also cause an association with metadata describing the condition of the physical item 204 to be encoded in the digital twin NFT 210, i.e., in addition to encoding the association with the fingerprint 206.

In this manner, a condition of the physical item 204 may be encoded separately from data that uniquely identifies the physical item 204 from other physical items, e.g., separately from the fingerprint 206. Due to this separate determination and encoding, the condition encoded by the digital twin NET 210 may change over time, but the fingerprint 206 of the item may not change over time. By way of example, the digital twin NFT 210 may encode an association with metadata that describes a condition of the item in terms of “new” or “used,” an amount the item is used, a relative amount of use compared to other items, an age of the item, and/or changes to the item from one or more previous times features of the item were captured, to name just a few. Consider a scenario, after the digital twin NFT 210 is minted, in which additional features of the physical item 204 are captured e.g., by sensors of one or more devices. The service provider system 104 is configured to compare the newly captured features to the sensor-captured features 202 used in connection with minting the digital twin NET 210. Based on this comparison, the service provider system 104 may determine that the condition of the physical item 204 has changed subsequent to minting the digital twin NET 210. Based on determining that the condition of the physical item 204 has changed over time, the service provider system 104 may update the metadata of the digital twin NET 210 via generation of additional NFT minting instructions 212 to indicate the changed condition of the physical item 204. Thus, the digital twin NFT 210 may encode a variety of information in relation to the physical item 204 in addition to the example described herein.

In the illustrated example, the listing platform 132 receives an NFT notification 216. The NFT notification 216 is representative of information describing a location of the digital twin NFT 210 on the blockchain 116. For example, the NFT notification 216 may include the token identifier of the digital twin NFT 210 and/or an address of a digital wallet of a current owner of the digital twin NFT 210. Although depicted as being received from the minting system 128, in implementations where a new NET is not to be minted for the physical item 204, NET notification is received directly from the fingerprint capture system 130. In implementations, the NFT notification 216 is received by the listing platform 132 in response to receiving a request to generate a listing for the digital twin NET 210, either separately from or together with the physical item 204.

In response to receiving the NET notification 216, the listing platform 132 generates a listing 218, which is representative of an offer for sale of the digital twin NFT 210, either together with or separate from its counterpart physical item 204. The listing 218 is depicted as including a smart contract template 220, which is representative of executable code configured to ensure performance of one or more obligations specified by the listing 218 as conditions for transferring the digital twin NFT 210 (e.g., payment of a specified price for the digital twin NFT 210, storage of the physical item 204 in the physical storage vault 144, return the digital twin NFT 210 to a user account that generated the listing 218 after a specified duration, and so forth). As described in further detail below, the smart contract template 220 is useable to generate a smart contract that facilitates transaction of the digital twin NFT 210 between user accounts (e.g., between digital wallet 150 and digital wallet 156) by updating the smart contract template 220 with information describing a purchaser of the digital twin NFT 210 via the listing 218.

In the illustrated example of FIG. 2, the listing platform 132 is depicted as outputting the listing 218. This output of the listing 218 may correspond to publishing the listing 218 to one or more client devices, e.g., associated with user accounts of the service provider system 104 or that navigate to user interfaces of the service provider system 104. By way of example, the listing 218 may be displayed or otherwise output by a web application (e.g., the application 146 or the application 152) via a user interface at the client devices 106, 108. In one or more implementations, the listing platform 132 exposes the listing 218 to a plurality of client devices, such that users navigating to the listing or searching for listings can view the listing 218.

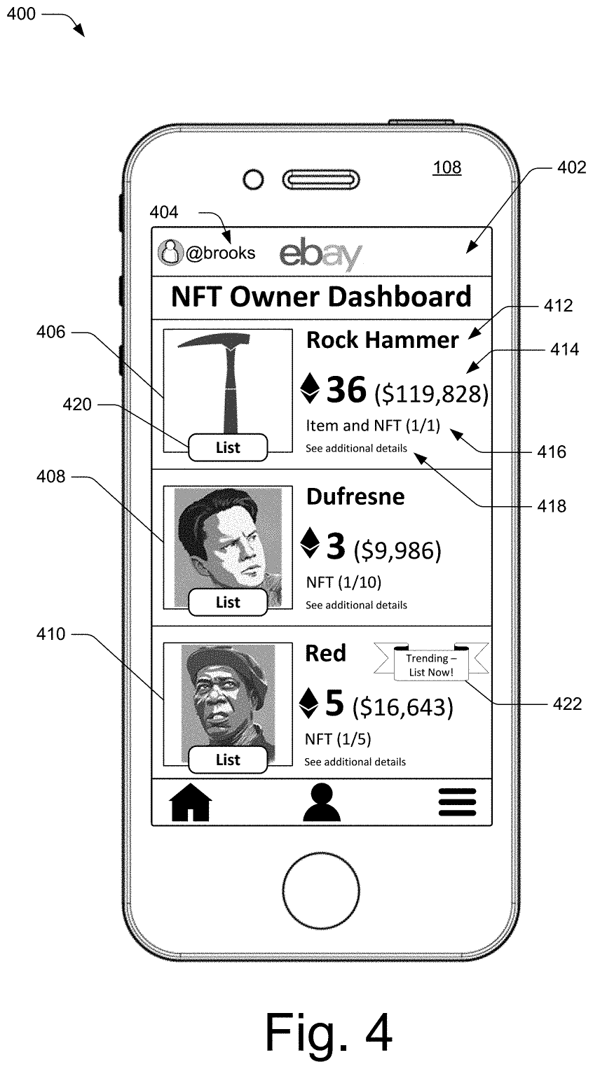

FIG. 3 depicts an example of a system 300 to transfer an NFT between digital wallets in response to purchase of the NFT via a listing. Functionality of the system 300 is described with reference to example user interfaces depicted in FIGS. 4-12, which are representative of user interfaces output by the service provider system 104 for listing an NET associated with a physical item and transferring the NET between digital wallets.

The illustrated example of FIG. 3 includes the client device 106 and its associated application 146, storage 148, and digital wallet 150, the client device 108 and its associated applications 152, storage 154, and digital wallet 156, and the listing platform 132 as introduced in FIG. 1. The NET dashboard module 136 of the listing platform 132 is configured to output an NET dashboard 302 for display at the client device 106. The NFT dashboard 302 is representative of one or more user interfaces configured to display information regarding NFTs for a user of the client device 108, such as NFTs stored in the digital wallet 156, NFTs related to those stored in the digital wallet 156, NFTs listed on the listing platform 132, NFTs transferred via the service provider system 104, combinations thereof, and so forth. In some implementations, the listing platform 132 provides the NFT dashboard 302 to the client device 108 responsive to receiving a request to view the NFT dashboard 302 via input to the application 152.

FIG. 4 depicts an example 400 of a user interface 402 including an NFT dashboard for a digital wallet. For instance, the illustrated example 400 depicts an example of the NET dashboard 302 configured for the digital wallet 156 and output for display at the client device 108. The user interface 402 indicates that the NET dashboard 302 is configured as an “NFT Owner Dashboard,” customized for a user account 404 of the service provider system 104 associated with the digital wallet 156, represented as the user “@brooks” in the illustrated example.

The user interface 402 of the example NET dashboard 302 depicts a plurality of NFTs owned by the user account 404, such as one or more NFTs stored in the digital wallet 156 of the client device 108. For instance, the user interface 402 indicates that the user account 404 owns NFT 406, NFT 408, and NFT 410. NFT 406 represents a digital twin NFT of a physical rock hammer, NFT 408 represents a digital twin NFT of physical artwork titled “Dufresne,” and NFT 410 represents a digital twin NFT of physical artwork titled “Red.”

The user interface 402 of the NFT dashboard 302 is configured to display additional information regarding each displayed NFT. For instance, with respect to the NFT 406, the user interface 402 includes a display of a title 412 for the NFT 406 along with an estimated value 414 for the NFT 406. The user interface 402 further includes a description of ownership information 416 for the NFT 406, which indicates that the user account 404 owns both the NFT 406 as well as its physical item counterpart (e.g., the physical rock hammer), and that the NFT 406 is the only digital twin NFT for the physical rock hammer. The user interface 402 additionally includes a selectable option 418 (e.g., a hyperlink) to view additional details regarding the NFT 406 and a selectable option 420 (e.g., a button) to generate a listing for sale of the NET 406.

In some implementations, the user interface 402 of the NFT dashboard 302 is configured to provide an indication regarding NFTs owned by the user account 404 that are trending. For instance, the user interface 402 includes a visual indication 422 configured as a banner noting that the NET 410 is currently trending. The listing platform 132 is configured to identify that an NFT is currently trending in a variety of manners. For instance, the listing platform 132 may identify that an NET is trending based on a number of searches that include one or more keywords pertaining to the NFT, based on a transaction history for the NFT, based on transactions for related NFTs, combinations thereof, and so forth. By displaying the visual indication 422 for a trending NFT, the NFT dashboard 302 is configured to inform a user associated with the user account 404 regarding aggregate user account behavior on the listing platform that suggests market interest in individual NFTs.

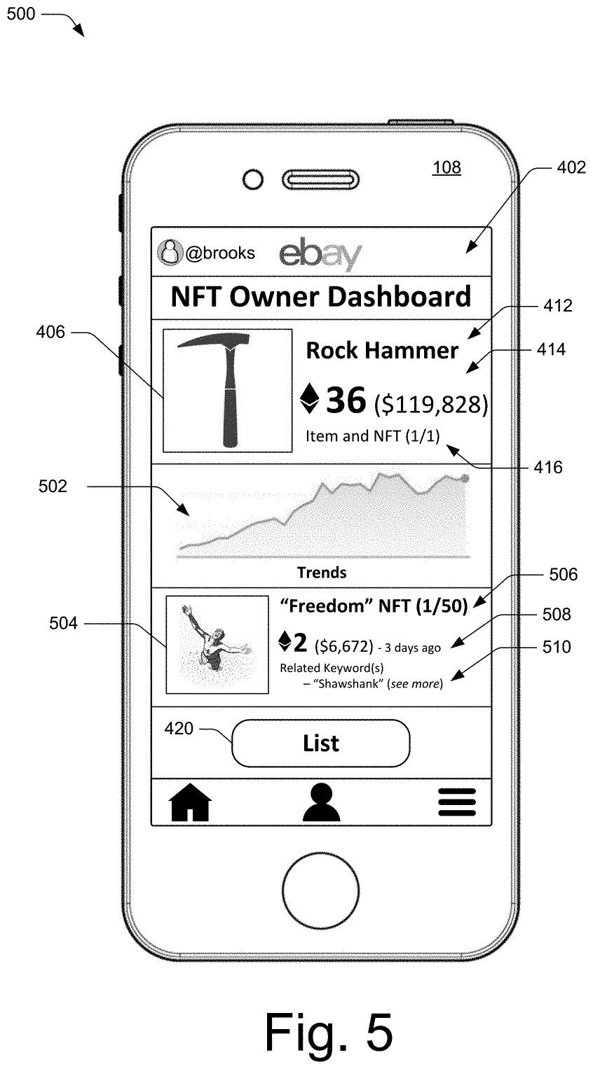

FIG. 5 depicts an example 500 of a user interface of the NFT dashboard 302, which includes additional details for NFT 406 and is presented responsive to user input selecting the selectable option 418. In the illustrated example, the user interface 402 is modified to depict additional information pertaining to the NFT 406. For instance, the user interface 402 is modified to depict information describing one or more trends 502 for the NFT 406. The information describing one or more trends 502 for the NFT 406 include, for example, an estimated value for the NFT 406, historical search terms related to the NFT 406 (e.g., submitted via user input to the listing platform 132, search engine, and the like), combinations thereof, and so forth.

The user interface 402 is further modified to display information regarding one or more NFTs that are related to the NET 406, such as related NFTs listed and/or transferred by the listing platform 132 that impact the one or more trends 502. For instance, the illustrated example of FIG. 5 includes a display of related NET 504, along with a description 506 indicating that the related NET 504 is titled “Freedom” and is one of 50 digital twin NFTs for its physical item counterpart. In some implementations, the user interface 402 is modified to display information describing an estimated value 508 for the related NET 504. The estimated value 508 may be gleaned from any suitable number of sources. For instance, in the illustrated example 500, the estimated value 508 indicates that the related NFT 504 was transferred via the listing platform 132 three days ago for a value of 2 ETH, which may correlate to a monetary valuation of $6,672 based on a current exchange rate for ETH and USD.

Alternatively or additionally, the information for the related NFT 504 provides an indication describing aspects that caused the listing platform 132 to identify the related NFT 504 as being related to the NFT 406. For instance, the illustrated example 500 includes relationship information 510 indicating that the NFT 406 and the related NFT 504 are both associated with the keyword “Shawshank.” In some implementations, the information displayed in the user interface 402 regarding the one or more NFTs that are related to the NFT 406 is updated based on a selection of the visual representation of the one or more trends 502. For instance, in an implementation where the one or more trends 502 are configured as a graph representation of how the NFT 406 is perceived to trend over time, input to a certain location on the graph representation causes the user interface 402 to display information regarding at least one related NET 504 that influenced the value represented by the certain location on the graph representation. In this manner, the NET dashboard 302 is configured to provide various displays of information regarding NFTs associated with a digital wallet and facilitate generating listings for the NFTs via the listing platform 132.

In response to detecting input at the selectable option 420 indicating an intent to list the NET 406, the listing platform 132 is configured to prompt a user (e.g., a user associated with the user account 404) to specify one or more listing obligations 304 to be included in a listing 306 for an NFT 308 (e.g., the NFT 406). To do so, the obligation module 134 of the listing platform 132 is configured to cause the client device 108 to output one or more user interfaces (e.g., via the application 152) that include prompts for user input defining various aspects of the listing 306.

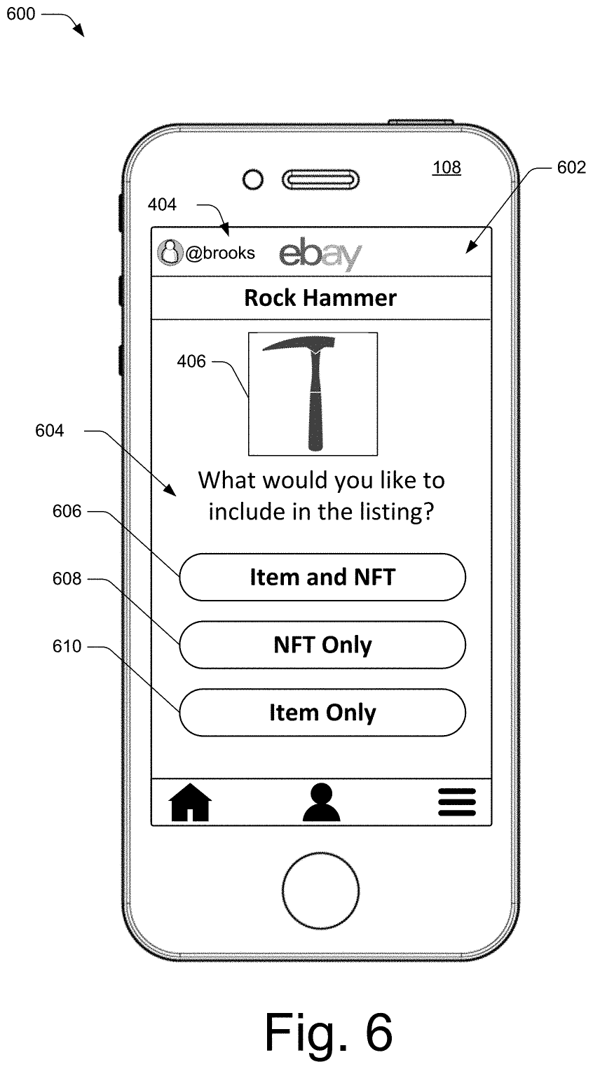

FIG. 6 depicts an example 600 of a user interface 602 output as part of generating a listing for an NFT associated with a physical object, such as NFT 406. In the illustrated example 600, the user interface 602 includes a prompt 604 regarding what is to be included as a subject of the listing for the NFT 406. Because the user account 404 owns both the NFT 406 and the physical rock hammer item from which the NFT 406 was minted, the user interface 602 includes three selectable options for specifying a subject of the listing: a selectable option 606 to list both the physical item and the NFT, a selectable option 608 to list the NFT only (i.e., independent of the physical rock hammer), and a selectable option to list the physical item only (i.e., independent of the NFT 406). User input at one of the selectable options 606, 608, or 610 thus defines the one or more subjects for the listing 306. For instance, responsive to receiving input at the selectable option 608, the listing platform 132 identifies the NFT 406 as the NFT 308 subject of the listing 306 and ascertains that any listing obligations 304 specified by the client device 108 define conditions for transferring the NET 308 from the digital wallet 156 to a different digital wallet. After identifying the one or more subjects of the listing 306, the obligation module 134 is configured to prompt a user associated with the user account 404 to define the listing obligations 304.

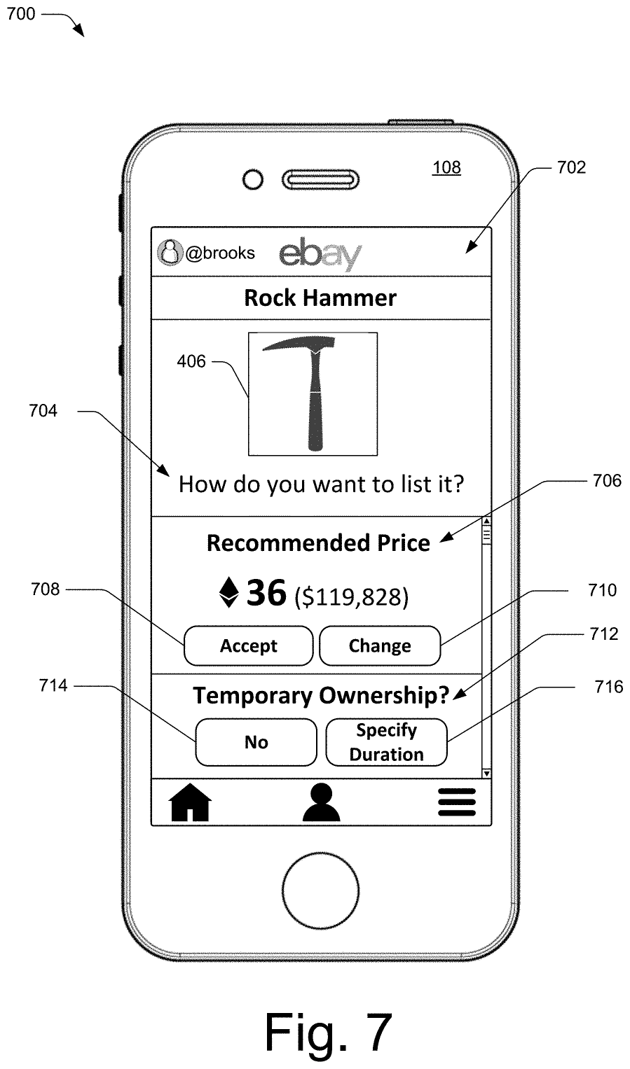

FIG. 7 depicts an example 700 of a user interface 702 output as part of prompting a user for feedback describing listing obligations 304 for generating a listing 306 for an NET 308. In the illustrated example 700, user interface 702 is depicted as identifying the NFT 308 that is the subject of the listing, such as NFT 406, along with a prompt 704 to define one or more aspects of the listing. To assist a user in generating the listing 306, the user interface 702 includes a recommended price 706 for the NFT 406, along with a selectable option 708 to accept the recommended price 706 and a selectable option 710 to specify a different price for listing the NFT 406. In response to detecting input specifying a price to be used for listing the NFT 406 (e.g., via input to one of the selectable options 708 or 710), the obligation module 134 is configured to generate a smart contract template 310 for the listing 306 that includes code configured to ensure that the specified price is paid by a purchaser of the listing 306 before transferring the NFT 308 from the digital wallet 156 to a digital wallet associated with the purchaser. In addition to including a prompt for specifying a price for the NFT 406, the user interface 702 is configured to include one or more prompts for input specifying a usage right to be conferred with the transfer of the NFT 406. In some implementations, the user interface 702 may include a prompt to specify a manner in which the NFT 308 can be purchased. For instance, the user interface 702 may enable a user to designate the NET 308 for listing via auction and set parameters for the auction (e.g., reserve value, minimum bid increment, auction start time, duration, and so forth).

For instance, the user interface 702 includes a prompt 712 for user input specifying whether the listing 306 is for temporary ownership of the NET 406. The prompt 712 is accompanied in the user interface 702 by a selectable control 714 to indicate that the NET 308 is not to be offered for sale with any temporal ownership restrictions. The prompt 712 is further accompanied by a selectable control 716 to specify a duration defining temporal constraints on ownership of the NET 406 when purchased via the listing 306. In this manner, the user interface 702 enables a user to curate a listing 306 for rental of the NFT 406 and/or the physical item from which the NFT 308 was minted. Temporary ownership (e.g., rental) of an NFT may be attractive to a purchasing entity for a variety of considerations, such as in an example scenario where the purchasing entity intends to curate an art exhibit and showcase digital twin NFTs of artwork that otherwise cannot be transported to a common physical location due to import restrictions, transportation risks, and so forth. In response to detecting input at the selectable control 716, the obligation module 134 is configured to generate the smart contract template 310 to include code that transfers the NFT 308 from a digital wallet associated with a purchaser to the digital wallet 156 upon expiration of the specified duration for temporal ownership. Alternatively, in an example implementation where input is detected at the selectable control 714, the user interface 702 may be modified to remove display of the prompt 712 and its associated selectable controls and present one or more additional prompts for input defining listing obligations 304 for the listing 306.

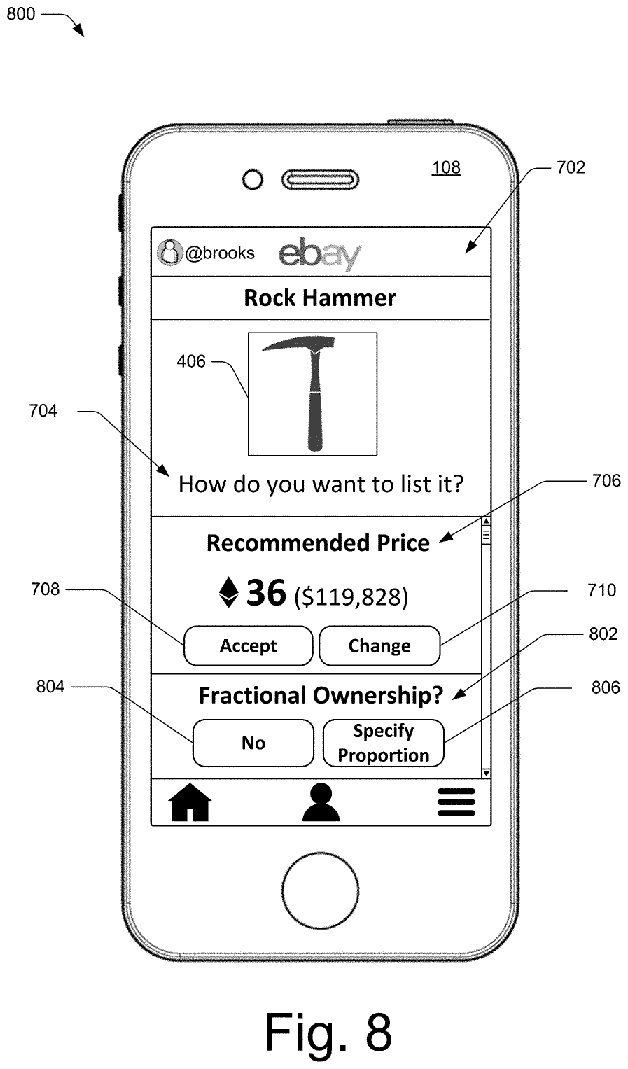

FIG. 8 depicts an example 800 of a user interface 702 output as part of prompting a user for feedback describing listing obligations 304 for generating a listing 306 for an NFT 308, such as an updated version of the user interface 702 depicted in FIG. 7 displayed in response to detecting input at the selectable control 714. In the illustrated example 800, the prompt 712 is replaced by a prompt 802 for user input specifying whether the listing 306 is for a fractional ownership of the NFT 406. Fractional ownership of an NET may be attractive to a purchasing entity in an example implementation where a value of the NET is cost-prohibitive for the purchasing entity to acquire outright ownership. The prompt 802 is accompanied by a selectable control 804 to indicate that a listing is to be generated offering full ownership of the NFT 406. The prompt 802 is further accompanied by a selectable control 806 to indicate that the listing is to offer a fractional ownership share of the NET 406 (e.g., a 25% ownership stake in the NFT 406). Based on input received at the selectable control 804 or the selectable control 806, the obligation module 134 configures the smart contract template 310 for the listing 306 to convey the respective ownership portion to a digital wallet of a purchasing user upon purchase of the NFT 308 via the listing 306 and record a record of the conveyed ownership in transaction data 126 stored on the blockchain 116.

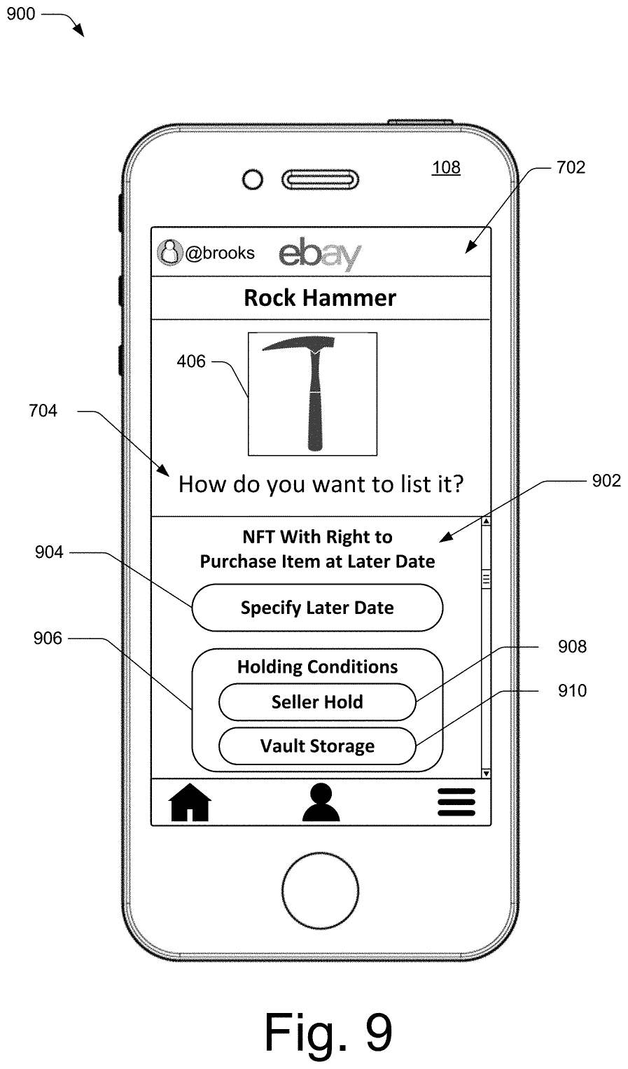

FIG. 9 depicts an example 900 of a user interface 702 output as part of prompting a user for feedback describing listing obligations 304 for generating a listing 306 for an NFT 308. In the illustrated example 900, the user interface 702 includes a prompt 902 for user input specifying whether the NFT 406 is to be offered for sale with a right to purchase the counterpart physical item at a later date. For instance, consider an example scenario where the subject NFT 308 is a digital twin of physical artwork. A purchasing entity may display the NET 308 at a digital art exhibit and want the option to later purchase the physical artwork, based on an audience reaction to the NET 308 at the digital art exhibit. In such an example scenario, the option to purchase the counterpart physical item at the later date might encourage the purchasing entity to include the NET 308 in the digital art exhibit.

The prompt 902 is accompanied by a selectable control 904 configured to receive user input defining a later date by which a purchaser of the listing 306 reserves the right to purchase a physical item corresponding to the subject of the listing 306 (e.g., the physical rock hammer from which the NET 406 was minted). Although illustrated in the context of providing an option to purchase a physical item at a later date, the prompt 902 may alternatively be configured for purchasing a digital twin NFT at a later date when its physical item counterpart is designated as the subject of the listing 306.

The user interface 702 in the illustrated example 900 further includes an option 906 to designate holding conditions for the physical item between a time of purchase of the NFT and the later date specified via input to the selectable control 904. For instance, the option 906 includes a selectable control 908 to designate that the physical item is to be held and maintained by the seller (e.g., the user associated with the user account 404 generating the listing 306) until the later date. The option 906 further includes a selectable control 910 to designate that the physical item is to be held and maintained in a physical storage vault (e.g., the physical storage vault 144 of FIG. 1) until the later date. A desirability of maintenance by a seller relative to maintenance in physical storage vault depends on the physical item to be stored, as well as a reputation of the particular seller. For instance, in an example scenario where the entity generating the listing 306 is a museum, maintenance by the museum may be more desirable than maintenance at a physical storage vault. Conversely, maintenance by an individual with minimal seller history may be less desirable than maintenance at the physical storage vault. In this manner, the selectable controls 908 and 910 are representative of functionality provided by the listing platform 132 to create a bespoke listing 306 customized according to a subject of the listing.

In response to input defining the later date at selectable control 904 and input at the selectable control 910, the listing platform 132 designates the listing obligations 304 to specify that a seller of the NET 406 is obligated to transfer the physical item counterpart for the NET 406 to the physical storage vault 144 as a condition of transferring the NFT 406 from a digital wallet of the seller to a digital wallet of a purchaser of the NET 406 via a listing published via the listing platform 132.

In response to receiving input at one or more of the selectable control 904, option 906, or selectable control 908, the obligation module 134 configures the smart contract template 310 for the listing 306 to ensure performance of the associated obligation as a condition to effectuating transfer of the subject NFT 308 of the listing 306. For instance, consider an example implementation where input at the user interface 702 of the illustrated example 900 indicates that the listing 306 is to offer the NFT 308 for sale with a right to purchase a physical item counterpart until a later date. If user input specifies that the physical item counterpart is to be stored in the physical storage vault 144 until the later date, the obligation module 134 configures the smart contract template 310 to verify delivery of the physical item counterpart to the physical storage vault 144 as a precondition of transferring the NFT 308. Consequently, when executed, the smart contract 314 does not transfer the NFT 308 to a digital wallet of a purchasing user until verifying delivery to the physical storage vault 144.

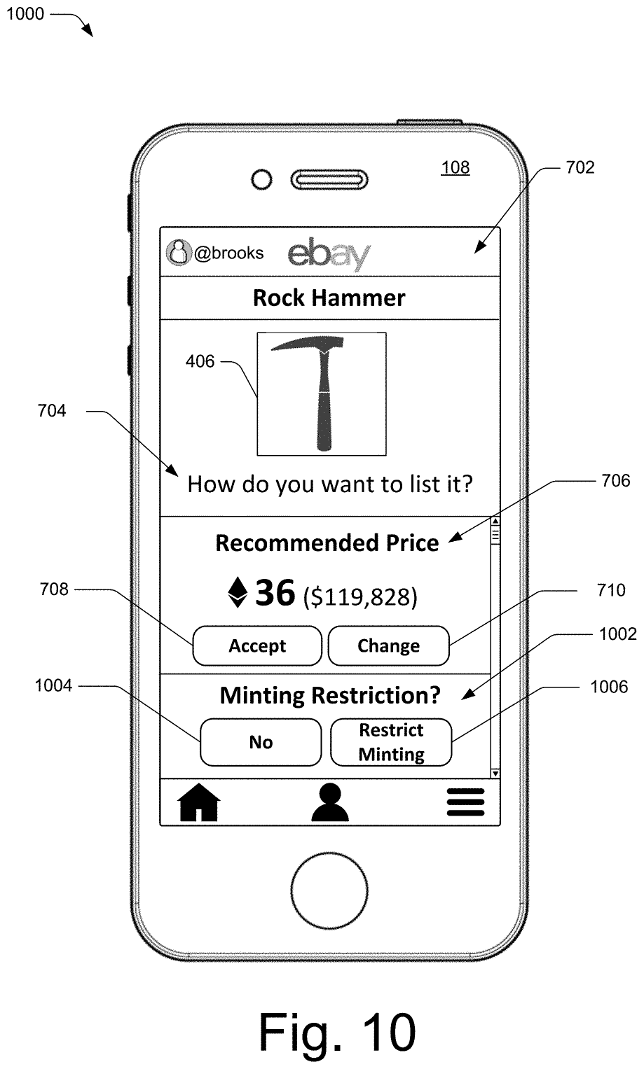

FIG. 10 depicts an example 1000 of a user interface 702 output as part of prompting a user for feedback describing listing obligations 304 for generating a listing 306 for an NFT 308, such as an updated version of the user interface 702 depicted in FIG. 7 displayed in response to detecting input at the selectable control 714 or an updated version of the user interface 702 depicted in FIG. 8 displayed in response to detecting input at the selectable control 804. In the illustrated example 1000, the user interface 702 is updated to include a display of prompt 1002, which requests user input indicating whether the listing 306 is to be associated with any restriction against minting additional digital twin NFTs of the physical item from which the NET 406 was minted. In this manner, display of prompt 1002 is conditional on input received at one of the selectable options 606 or 610 displayed in the illustrated example of FIG. 6, such that a physical item associated with a digital twin NET comprises at least a portion of the listing 306.

In response to detecting input at the selectable option 1004, the listing 306 is generated free of encumbrances against minting additional digital twin NFTs of a physical item from which the NFT 308 was minted. Alternatively, in response to detecting input at the selectable option 1006, the listing 306 is generated to include an indication that the offer for sale of the physical item associated with the NFT 308 precludes a purchasing entity from minting more than a threshold number of additional digital twin NFTs of the physical item. In an example implementation where input is detected at the selectable option 1006, the obligation module 134 is configured to generate the smart contract template 310 to include code that restricts the minting system 128 from generating NET minting instructions 212 for a fingerprint 206 corresponding to the physical item for the listing 306 from which the subject NET 308 was minted. The selectable option 1006 thus enables an entity generating the listing 306 to govern an exclusivity associated with the NET 308 (e.g., to ensure that the NET 308 remains a sole digital twin of the counterpart physical item) and otherwise define additional aspects of an NET-subject transaction not supported by conventional listing platforms.

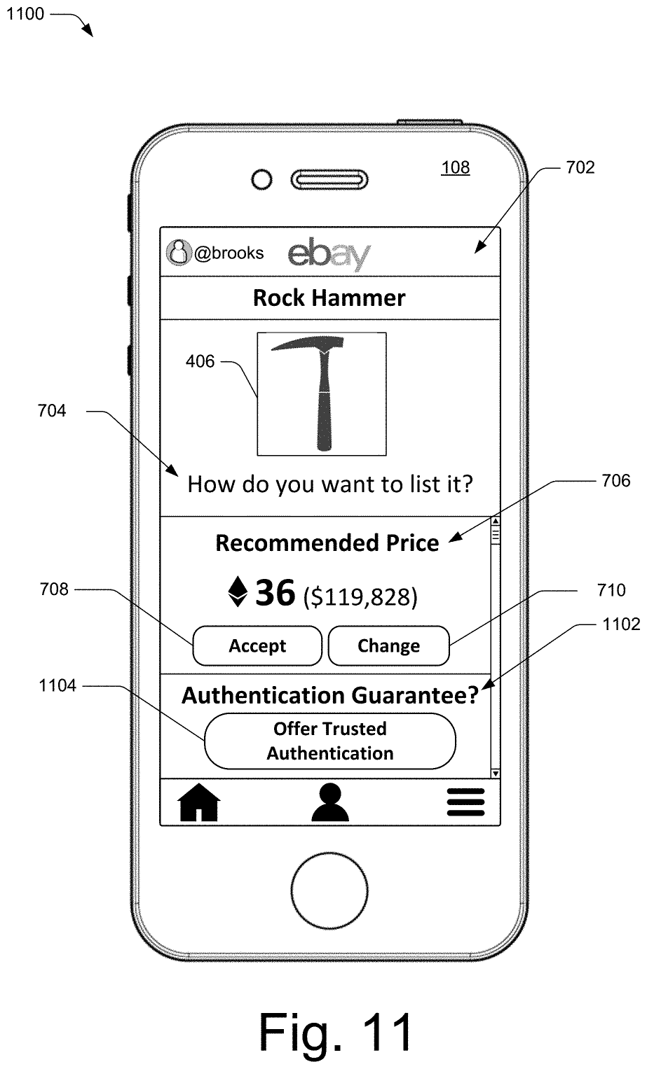

FIG. 11 depicts an example 1100 of a user interface 702 output as part of prompting a user for feedback describing listing obligations 304 for generating a listing 306 for an NET 308. For instance, the user interface 702 depicted in the illustrated example 1100 is output in response to detecting input at the selectable control 714, detecting input at the selectable control 804, or detecting input at the selectable option 1004. In the illustrated example 1100, the user interface 702 is updated to include a display of prompt 1102, which requests user input indicating whether the listing 306 is to be offered with a trusted authentication guarantee. In response to detecting input at the selectable option 1104, for instance, the listing 306 is generated to include an obligation for a seller of the NET 406 to transfer a physical item from which the NET 406 was minted (e.g., the physical rock hammer) to a third-party authenticator (e.g., the authentication service system 138) to verify that the physical rock hammer is indeed authentic.

In response to detecting input at the selectable option 1104, the obligation module 134 is configured to update the smart contract template 310 for the listing to include code that verifies authentication of the physical item counterpart for the subject NFT 308 of the listing 306 by the authentication service system 138 before transferring the NFT 308 from a digital wallet of a selling entity (e.g., digital wallet 156) to a digital wallet of a purchasing entity. Thus, the obligation module 134 is configured to provide a variety of different user interfaces that enable a seller of a physical item, its digital twin NET, or a combination thereof, to specify particular obligations invoked as part of transferring the subject of the listing from the seller to a purchaser. In addition to providing these user interfaces, the obligation module 134 is configured to generate a smart contract template 310 that includes code configured to facilitate transfer of the subject of the listing 306 and ensure performance of the listing obligations 304 as a condition to transferring the subject of the listing 306 (e.g., the NET 308).

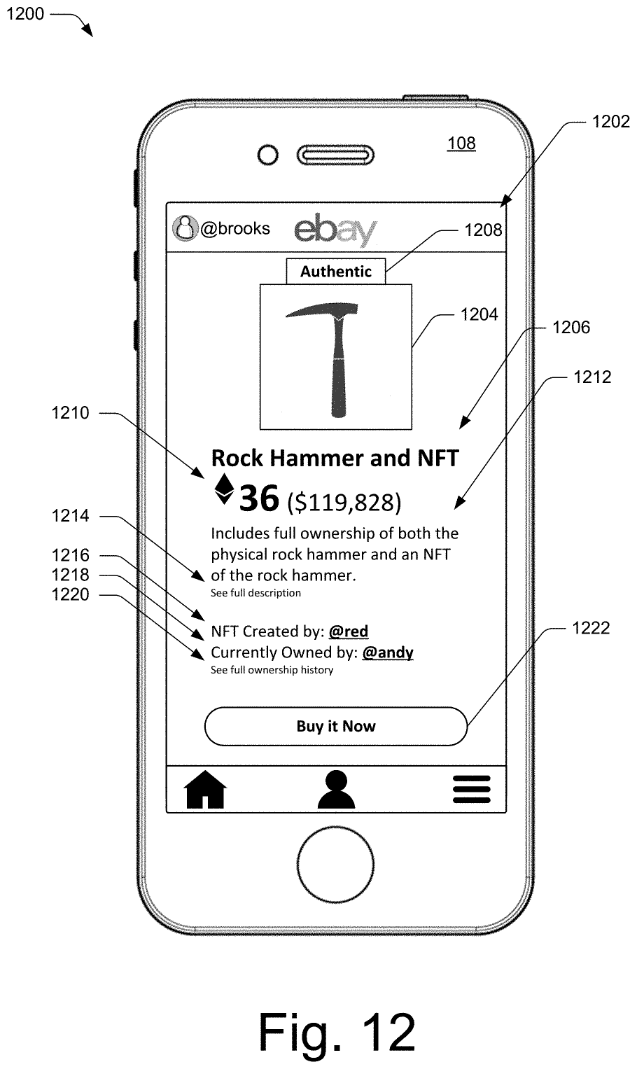

Returning to FIG. 3, the listing platform 132 is depicted as outputting the listing 306. Output of the listing 306 is representative of publishing the listing 306 to a plurality of client devices, including the client device 106 as depicted in the illustrated example. For example, the listing 306 may be displayed as part of, or otherwise output by, an application (e.g., the applications 146) via a user interface at the client device 106. In implementations, the listing platform 132 is configured to expose the listing 306 to a plurality of client devices, such that users navigating to the listing or searching for listings can view the listing 306. Although illustrated as including the NFT 308, in implementations the listing platform 132 may not actually obtain the NFT 308 or the physical item counterpart from which the NFT 308 was minted. Instead, the listing platform 132 is configured to obtain an indication that the NFT 308 and/or its physical item counterpart are to be listed via the platform. In such implementations where the NFT 308 and/or its counterpart physical item are not obtained by the listing platform 132, the listing platform 132 is configured to verify ownership of the NFT 308 and/or its physical item counterpart by a user account generating the listing 306 (e.g., by verifying that a public address encoded in the NET 308 corresponds to an address of the user account generating the listing 306). As depicted in FIG. 12, the listing 306 includes an option that is selectable by a user of the client device 106 to purchase the subject of the listing 306 (e.g., the NFT 308).

FIG. 12 depicts an example 1200 of a listing for an NET associated with a physical item, such as an example of listing 306. The illustrated example 1200 depicts a user interface 1202 that displays a listing for an NET 1204 and a physical item counterpart from which the NFT 1204 was minted. The user interface 1202 includes a title 1206, a price 1210, a brief description 1212, and a selectable option 1214 to view a complete description for the listing, which collectively indicate that the listing offers “full ownership of both the physical rock hammer and an NFT of the rock hammer” for 36 ETH, which is estimated to equate to $119,828. The user interface 1202 further depicts an authenticity indicator 1208, which indicates that the physical item rock hammer has been verified as being authentic by the authentication service system 138.

The example listing of the user interface 1202 further includes lineage information for the subject of the listing, such as an indicator 1216 of an original creator of the NFT 308 and an indicator 1218 of a current owner of the subject of the listing (e.g., the NFT 308 and the physical item counterpart). The user interface 1202 further includes a selectable option 1220 to see full ownership history for the subject of the listing (e.g., an option to inspect a ledger tracking an ownership history of the NFT 308). The user interface 1202 further includes a selectable control 1222 to accept the terms of the listing and initiate transfer of the subject of the listing from a seller account to a purchasing account. For instance, in an example implementation where a user account identifier @brooks purchases the rock hammer and the NET offered via the listing in the user interface 1202, in response to verifying completion of the requisite listing obligations 304 (e.g., payment of the 36 ETH), then ownership of the rock hammer and NFT will be transferred from the @andy user account to the @brooks user account and the central ledger accessible via the selectable option 1220 will be updated to reflect the ownership transfer change.

In response to detecting input initiating an ownership transfer of a subject of the listing 306 (e.g., input purchasing the NFT 308 via the listing 306 through input at the selectable control 1222), the client device 106 generates a transfer request 312, which digitally persist the request by the user of the client device 106 to transfer ownership of the NFT 308 from the digital wallet 156 to the digital wallet 150. The transfer request 312 also persists acceptance of the one or more listing obligations 304 associated with the listing 306. In the illustrated example of FIG. 3, the listing platform 132 is depicted as receiving the transfer request 312.

Based on the transfer request 312, the listing platform 132 a smart contract 314 that includes NFT transfer instructions 316 and provides the smart contract 314 to at least one node 112 in the network 114 of nodes among which the blockchain 116 is distributed. In implementations, the listing platform 132 is configured to generate the smart contract 314 by updating the smart contract template 310 to include information describing an entity that purchases the subject of the listing 306 (e.g., an address of the digital wallet 150). The NFT transfer instructions 316 are thus representative of data configured according to a token standard (e.g., ERC-721 or ERC-1155) that causes ownership transfer of the NET 308.

Information included in the NET transfer instructions 316 of the smart contract 314 thus enables a node 112 to programmatically encode in the NFT 308 information included in the NET transfer instructions 316. For instance, the NET transfer instructions 316 may include an identifier associated with a user account to which ownership of the NET 308 is being transferred and the nodes 112 encode this identifier into the NET upon validation of the transfer (e.g., upon validation of performance of the listing obligations 304 codified in the smart contract 314. Once validated, the transfer is persisted in the transaction data 126 of the blockchain 116, including details about the transfer such as the identifier associated with the user account.

By way of example, the NET transfer instructions 316 may include a first address of a digital wallet which corresponds to a user account that owns the NET 308 (e.g., digital wallet 156) and include a second address of a digital wallet which corresponds to the user account to which ownership of the NET 308 is being transferred (e.g., digital wallet 150). Here, the first and second addresses may correspond to the identifiers of the respective users of computing devices 108 and 106. The NET transfer instructions 316 may also include public keys associated with the addresses of those digital wallets, which one or more of the nodes 112 use to validate the transaction (i.e., the transfer to the user account corresponding to the client device 106 and the digital wallet 150). This validation may include interacting with the client device 106 and a device of the user account that owns the NET 308 (e.g., client device 108), so that their private keys can be used to verify that the transfer is a legitimate transfer of the NFT 308.

As with other transactions on the blockchain 116, one or more of the nodes 112 determines whether the transfer of the NET 308 to the user account is valid (e.g., using a consensus mechanism). If the nodes 112 determine that the transfer to the user account is a valid transaction, the nodes 112 commit the valid transfer to the blockchain 116. To do so, the nodes 112 may cause the public wallet addresses of the parties to the transaction (including the public address of the digital wallet 150) to be digitally recorded in the NET 308's data on the blockchain 116. The NFT transfer instructions 316 may cause other data to be encoded into the NET 308 to describe the transaction.

Having discussed exemplary details of the techniques for listing an NET associated with a physical item and transferring the NET between digital wallets, consider now some examples of procedures to illustrate additional aspects of the techniques.

### Example Procedures

This section describes examples of procedures for listing an NET associated with a physical item and transferring the NET between digital wallets. Aspects of the procedures may be implemented in hardware, firmware, or software, or a combination thereof. The procedures are shown as a set of blocks that specify operations performed by one or more devices and are not necessarily limited to the orders shown for performing the operations by the respective blocks.

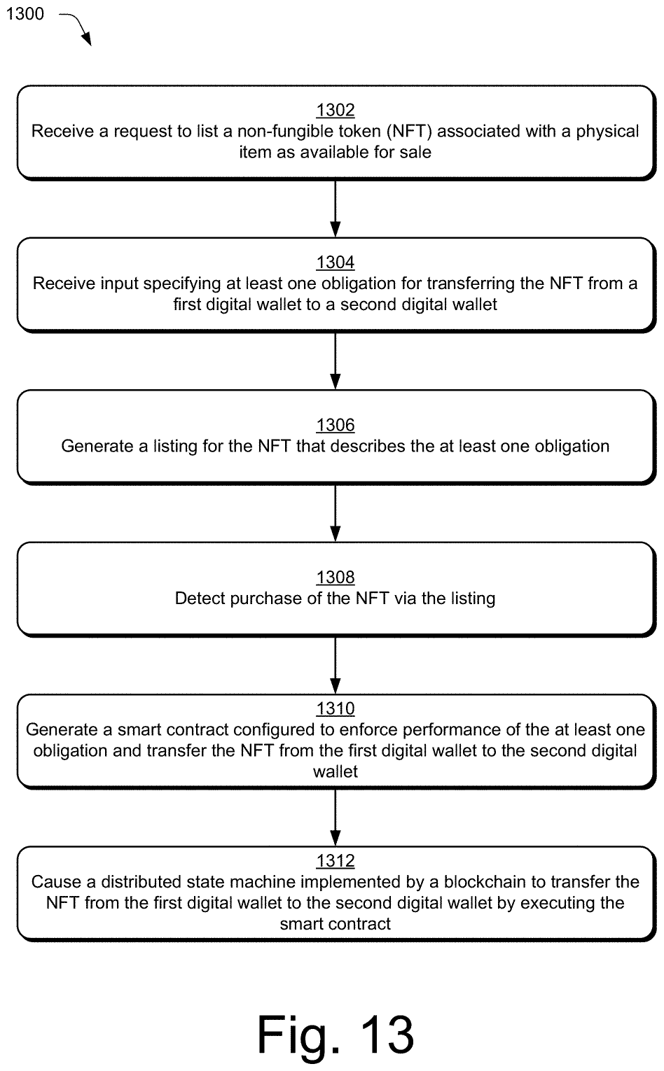

FIG. 13 depicts a procedure 1300 in an example implementation of listing an NFT associated with a physical item and transferring the NET between digital wallets.

A request to list an NFT associated with a physical item as available for sale is received (block 1302). By way of example, the listing platform 132 receives an NET notification 216 from a client device 108 to generate a listing for an NET 308. Input specifying at least one obligation for transferring the NET from a first digital wallet to a second digital wallet is then received (block 1304). The listing platform 132, for instance, receives listing obligations 304 from the client device 108. In example implementations, listing obligations 304 are received via input at one or more user interfaces provided by the obligation module 134, such as the example user interfaces 602 and 702 as depicted in FIGS. 6-11.

A listing is then generated for the NFT that describes the at least one obligation (block 1306). The listing platform 132, for example, generates the listing 306 for the NFT 308 with a smart contract template 310 that includes code configured to ensure performance of the listing obligations 304 and transfer the NFT 308 from the digital wallet 156 to a digital wallet of a purchasing user account in response to verifying performance of the listing obligations 304. As part of generating the listing 306, such as the example listing depicted in the user interface 1202, the listing platform 132 publishes the listing 306 for access by one or more computing devices, such that the client device 106 can view the user interface 1202 via, e.g., the application 146.

A purchase of the NFT is detected via the listing (block 1308). The listing platform 132, for instance, receives a transfer request 312 from the client device 106, which is generated by the client device 106 in response to detecting user input at the selectable control 1222 of the example listing of the user interface 1202. In response to detecting purchase of the NET, a smart contract configured to enforce performance of the at least one obligation and transfer the NFT from the first digital wallet to the second digital wallet is generated (block 1310). The listing platform 132, for instance, updates the smart contract template 310 of the listing 306 to include information identifying the digital wallet 150 of the client device 106 from which the transfer request 312 was received.

A distributed state machine implemented by a blockchain is then caused to transfer the NET from the first digital wallet to the second digital wallet by executing the smart contract (block 1312). The listing platform 132, for instance, communicates the smart contract 314 to a node 112 of the blockchain 116 and causes the node 112 to execute the NFT transfer instructions 316 included in the smart contract 314 by first verifying performance of the listing obligations 304 associated with the listing 306 and transfer the NFT 308 from the digital wallet 156 to the digital wallet 150 responsive to verifying performance of the listing obligations 304. Execution of the smart contract 314 causes the 112 to record both the specific code set forth in the smart contract 314 as well as results of executing the specific code as transaction data 126 stored on the blockchain 116.

Having described examples of procedures in accordance with one or more implementations, consider now an example of a system and device that can be utilized to implement the various techniques described herein.

### Example System and Device

FIG. 14 illustrates an example of a system generally at 1400 that includes an example of a computing device 1402 that is representative of one or more computing systems and/or devices that may implement the various techniques described herein. This is illustrated through inclusion of the service provider system 104. The computing device 1402 may be, for example, a server of a service provider, a device associated with a client (e.g., a client device), an on-chip system, and/or any other suitable computing device or computing system.

The example computing device 1402 as illustrated includes a processing system 1404, one or more computer-readable media 1406, and one or more I/O interfaces 1408 that are communicatively coupled, one to another. Although not shown, the computing device 1402 may further include a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 1404 is representative of functionality to perform one or more operations using hardware. Accordingly, the processing system 1404 is illustrated as including hardware elements 1410 that may be configured as processors, functional blocks, and so forth. This may include implementation in hardware as an application specific integrated circuit or other logic device formed using one or more semiconductors. The hardware elements 1410 are not limited by the materials from which they are formed or the processing mechanisms employed therein. For example, processors may be comprised of semiconductor(s) and/or transistors (e.g., electronic integrated circuits (ICs)). In such a context, processor-executable instructions may be electronically executable instructions.

The computer-readable media 1406 is illustrated as including memory/storage 1412. The memory/storage 1412 represents memory/storage capacity associated with one or more computer-readable media. The memory/storage 1412 may include volatile media (such as random-access memory (RAM)) and/or nonvolatile media (such as read only memory (ROM), Flash memory, optical disks, magnetic disks, and so forth). The memory/storage 1412 may include fixed media (e.g., RAM, ROM, a fixed hard drive, and so on) as well as removable media (e.g., Flash memory, a removable hard drive, an optical disc, and so forth). The computer-readable media 1406 may be configured in a variety of other ways as further described below.

Input/output interface(s) 1408 are representative of functionality to allow a user to enter commands and information to computing device 1402, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., which may employ visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 1402 may be configured in a variety of ways as further described below to support user interaction.

Various techniques may be described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques may be implemented on a variety of commercial computing platforms having a variety of processors.

An implementation of the described modules and techniques may be stored on or transmitted across some form of computer-readable media. The computer-readable media may include a variety of media that may be accessed by the computing device 1402. By way of example, and not limitation, computer-readable media may include “computer-readable storage media” and “computer-readable signal media.”

“Computer-readable storage media” may refer to media and/or devices that enable persistent and/or non-transitory storage of information in contrast to mere signal transmission, carrier waves, or signals per se. Thus, computer-readable storage media refers to non-signal bearing media. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media may include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which may be accessed by a computer.

“Computer-readable signal media” may refer to a signal-bearing medium that is configured to transmit instructions to the hardware of the computing device 1402, such as via a network. Signal media typically may embody computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 1410 and computer-readable media 1406 are representative of modules, programmable device logic and/or fixed device logic implemented in a hardware form that may be employed in some embodiments to implement at least some aspects of the techniques described herein, such as to perform one or more instructions. Hardware may include components of an integrated circuit or on-chip system, an application-specific integrated circuit (ASIC), a field-programmable gate array (FPGA), a complex programmable logic device (CPLD), and other implementations in silicon or other hardware. In this context, hardware may operate as a processing device that performs program tasks defined by instructions and/or logic embodied by the hardware as well as a hardware utilized to store instructions for execution, e.g., the computer-readable storage media described previously.

Combinations of the foregoing may also be employed to implement various techniques described herein. Accordingly, software, hardware, or executable modules may be implemented as one or more instructions and/or logic embodied on some form of computer-readable storage media and/or by one or more hardware elements 1410. The computing device 1402 may be configured to implement particular instructions and/or functions corresponding to the software and/or hardware modules. Accordingly, implementation of a module that is executable by the computing device 1402 as software may be achieved at least partially in hardware, e.g., through use of computer-readable storage media and/or hardware elements 1410 of the processing system 1404. The instructions and/or functions may be executable/operable by one or more articles of manufacture (for example, one or more computing devices 1402 and/or processing systems 1404) to implement techniques, modules, and examples described herein.

The techniques described herein may be supported by various configurations of the computing device 1402 and are not limited to the specific examples of the techniques described herein. This functionality may also be implemented all or in part through use of a distributed system, such as over a “cloud” 1414 via a platform 1416 as described below.

The cloud 1414 includes and/or is representative of a platform 1416 for resources 1418. The platform 1416 abstracts underlying functionality of hardware (e.g., servers) and software resources of the cloud 1414. The resources 1418 may include applications and/or data that can be utilized while computer processing is executed on servers that are remote from the computing device 1402. Resources 1418 can also include services provided over the Internet and/or through a subscriber network, such as a cellular or Wi-Fi network.

The platform 1416 may abstract resources and functions to connect the computing device 1402 with other computing devices. The platform 1416 may also serve to abstract scaling of resources to provide a corresponding level of scale to encountered demand for the resources 1418 that are implemented via the platform 1416. Accordingly, in an interconnected device embodiment, implementation of functionality described herein may be distributed throughout the system 1400. For example, the functionality may be implemented in part on the computing device 1402 as well as via the platform 1416 that abstracts the functionality of the cloud 1414.

### CONCLUSION

Although the systems and techniques have been described in language specific to structural features and/or methodological acts, it is to be understood that the systems and techniques defined in the appended claims are not necessarily limited to the specific features or acts described. Rather, the specific features and acts are disclosed as example forms of implementing the claimed subject matter.

What is claimed is:

1. A method implemented by at least one computing device, the method comprising:
receiving, by the at least one computing device, a request to list a non-fungible token (NFT) associated with a physical item as available for sale, the NET being stored on a blockchain and encoded with an address of a first digital wallet associated with a user account;
receiving, by the at least one computing device, input specifying at least one obligation for transferring the NET from the first digital wallet to a second digital wallet;
generating, by the at least one computing device, a listing for the NFT that describes the at least one obligation;
detecting, by the at least one computing device, purchase of the NFT via the listing;
generating, by the at least one computing device, a smart contract responsive to detecting the purchase of the NFT via the listing, the smart contract being configured to verify performance of the at least one obligation and transfer the NFT from the first digital wallet to the second digital wallet responsive to verifying performance of the at least one obligation; and
causing, by the at least one computing device, a distributed state machine implemented by a blockchain to transfer the NET from the first digital wallet to the second digital wallet by executing the smart contract.

2. The method of claim 1, wherein the second digital wallet is associated with a different user account and the smart contract is configured to encode an address of the second digital wallet in blockchain data associated with the NET responsive to detecting the purchase of the NET.

3. The method of claim 1, wherein generating the listing for the NET comprises identifying one or more previous owners of the NFT or the physical item via information encoded in the NET and including a display of at least one of the one or more previous owners or information describing the physical item in the listing.

4. The method of claim 1, wherein receiving the request to list the NET comprises receiving a first request to list the NET and the physical item as available for sale or a second request to list the NET as available for sale separately from the physical item.

5. The method of claim 1, further comprising receiving input specifying at least one usage right for the NET to be conferred with the transfer of the NET, wherein the listing for the NET describes the at least one usage right and the smart contract is further configured to encode the at least one usage right into the NET.

6. The method of claim 5, wherein the at least one usage right comprises an option to purchase the physical item at a later date, wherein the at least one obligation comprises storing the physical item in a vault until the later date.

7. The method of claim 5, wherein the at least one usage right comprises an ownership duration that expires at a later date, wherein the smart contract is further configured to transfer the NET from the second digital wallet to the first digital wallet after the later date.

8. The method of claim 5, wherein the at least one usage right comprises a fractional ownership of the NET.

9. The method of claim 1, wherein the at least one obligation comprises a restriction against minting additional digital copies of the physical item, the smart contract being configured to restrict a user account associated with the second digital wallet from minting an additional NFT of the physical item.

10. The method of claim 1, wherein the at least one obligation comprises transferring at least one of the physical item or the NFT to an authentication service for authentication prior to transferring the NFT from the first digital wallet to the second digital wallet.

11. The method of claim 1, further comprising causing display of a NFT dashboard, the NFT dashboard including at least one of a recommended price for the NFT, a trending price for at least a second NFT sharing one or more characteristics with the NFT, or trending searches for one or more keywords associated with the NFT, wherein the at least one obligation comprises a price for purchasing the NFT.

12. The method of claim 1, wherein generating the listing for the NET comprises displaying an authenticated indicator in the listing verifying that the NET is a legitimate digital copy of the physical item.

13. The method of claim 1, wherein generating the listing for the NET comprises generating a link that is selectable to inspect a central ledger that tracks information describing transfers of physical items and NFTs for one or more digital platforms and including the link in the listing.

14. The method of claim 1, further comprising:
detecting interest in at least one of the physical item or the NFT based on user behavior information collected by a digital service platform;
generating a notification that includes a selectable option to list the NFT as available for sale responsive to detecting the interest; and
outputting the notification at a client device, wherein receiving the request to list the NET as available for sale comprises receiving input at the client device selecting the selectable option.

15. A system comprising:
at least one processor; and
a computer-readable storage medium storing instructions that are executable by the at least one processor to perform operations comprising:
outputting a display of a user interface that includes a non-fungible token (NET) dashboard for a digital wallet, the NET dashboard depicting, for an NET stored in the digital wallet, information describing the NET and a selectable option to list the NET for sale;
detecting input at the selectable option;
responsive to detecting the input, modifying the user interface to display a recommended price for the NET and at least one option for defining an obligation to be performed as a condition of transferring the NET from the digital wallet to a different digital wallet;
generating a listing for the NET and a smart contract template for the listing, the smart contract template including instructions configured to ensure performance of the obligation and transfer the NFT from the digital wallet to the different digital wallet; and
publishing the listing via a digital marketplace.

16. The system of claim 15, wherein the at least one option for defining the obligation includes an option to accept or change the recommended price for the NET and generating the listing comprises including a price for the NET specified via the option to accept or change the recommended price.

17. The system of claim 15, wherein the selectable option to list the NET for sale comprises a visual indication that the NET is currently trending based on data describing user account behavior with the digital marketplace.

18. The system of claim 15, wherein the information describing the NFT comprises transaction information for a second NFT sharing one or more characteristics with the NFT.

19. The system of claim 15, wherein the information describing the NFT includes at least one of trending searches for one or more keywords associated with the NFT or historical price estimates for the NFT.

20. A computer-readable storage medium storing instructions that are executable by at least one computing device to perform operations comprising:
displaying a listing for sale of a non-fungible token (NFT) that is associated with a physical item and stored in a first digital wallet;
receiving input from an account associated with a second digital wallet indicating an agreement to purchase the NET by performing one or more obligations set forth in the listing;
identifying a smart contract template associated with the listing;
generating a smart contract by incorporating an identifier of the second digital wallet into the smart contract template, the smart contract being configured to transfer the NET from the first digital wallet to the second digital wallet and ensure performance of the one or more obligations; and
causing a distributed state machine implemented by a blockchain to transfer the NFT from the first digital wallet to the second digital wallet by executing the smart contract.
